(19) United States
(12) Patent Application Publication
(10) Pub. No.: US 2018/0173666 A1
(43) Pub. Date: Jun. 21, 2018

(54) APPARATUSES AND METHODS TO COUPLE AN EMBEDDED UNIVERSAL SERIAL BUS (eUSB) CIRCUIT TO A UNIVERSAL SERIAL BUS (USB) TRANSCEIVER INTERFACE CIRCUIT

(71) Applicant: INTEL CORPORATION, Santa Clara, CA (US)

(72) Inventor: AMIT KUMAR SRIVASTAVA, Penang (MY)

(21) Appl. No.: 15/382,542

(22) Filed: Dec. 16, 2016

(51) Int. Cl. G06F 13/42; H04L 29/06; H04L 27/00; G06F 13/36; G06F 13/40

(52) U.S. Cl. CPC G06F 13/4282; H04L 69/18; H04L 27/0002; G06F 2213/0042; G06F 13/36; G06F 13/4068; H04L 69/08

(57) ABSTRACT

Methods and apparatuses relating to circuitry to couple an embedded Universal Serial Bus (eUSB) circuit to a Universal Serial Bus (USB) transceiver interface circuit are described. In one embodiment, an apparatus includes an analog front end circuit to couple to a device; a transceiver interface circuit to couple to a serial bus controller; and an adapter circuit coupled between the analog front end circuit and the transceiver interface circuit to convert between a first protocol of the analog front end circuit and a second, different protocol of the transceiver interface circuit.

### TECHNICAL FIELD

The disclosure relates generally to electronics, and, more specifically, an embodiment of the disclosure relates to circuitry to couple an embedded Universal Serial Bus (eUSB) circuit to a Universal Serial Bus (USB) transceiver interface circuit.

### BACKGROUND

Electronics (e.g., computer systems) generally employ one or more electrical connections to facilitate the transmittal of data (e.g., communication) between devices, such as between a computing system and a (e.g., external) peripheral.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a schematic diagram of a serial bus circuit including an adapter circuit according to embodiments of the disclosure.

FIG. 2 illustrates a schematic diagram of a serial bus circuit including an adapter circuit according to embodiments of the disclosure.

FIG. 3 illustrates a schematic diagram of an adapter circuit coupled to an analog front end circuit according to embodiments of the disclosure.

FIG. 4 illustrates a high speed transmit and high speed receive timing diagram of a serial bus circuit including an adapter circuit according to embodiments of the disclosure.

FIG. 5 illustrates a classic speed transmit and classic speed receive timing diagram of a serial bus circuit including an adapter circuit according to embodiments of the disclosure.

FIG. 6 illustrates a state timing diagram of a serial bus circuit including an adapter circuit according to embodiments of the disclosure.

FIG. 7 illustrates a flow diagram for a serial bus circuit including an adapter circuit according to embodiments of the disclosure.

FIG. 8 illustrates a flow diagram for a serial bus circuit including an adapter circuit according to embodiments of the disclosure.

FIG. 9 illustrates a schematic diagram of a serial bus circuit including an adapter circuit coupled to a repeater circuit according to embodiments of the disclosure.

FIG. 10 illustrates an analog front end circuit according to embodiments of the disclosure.

FIG. 11 illustrates an analog front end circuit according to embodiments of the disclosure.

FIG. 12 illustrates a computing system including a peripheral component interconnect express (PCIe) compliant architecture according to embodiments of the disclosure.

FIG. 13 illustrates a PCIe compliant interconnect architecture including a layered stack according to embodiments of the disclosure.

FIG. 14 illustrates a PCIe compliant request or packet to be generated or received within an interconnect architecture according to embodiments of the disclosure.

FIG. 15 illustrates a transmitter and receiver pair for a PCIe compliant interconnect architecture according to embodiments of the disclosure.

FIG. 16 illustrates a computing system on a chip according to embodiments of the disclosure.

FIG. 17 illustrates an embodiment of a block diagram for a computing system.

FIG. 18 illustrates another embodiment of a block diagram for a computing system.

FIG. 19 illustrates another embodiment of a block diagram for a computing system.

### DETAILED DESCRIPTION

In the following description, numerous specific details are set forth. However, it is understood that embodiments of the disclosure may be practiced without these specific details. In other instances, well-known circuits, structures, and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Electronics (e.g., computing systems) generally employ one or more electrical couplings (e.g., wired or wireless connections) to facilitate the transmission and reception of data (e.g., communication) between devices (e.g., out-of-the-box communications), such as, but not limited to, between a computing system (e.g., a computer including a hardware processor) and a (e.g., external) peripheral. Non-limiting examples of peripherals are a keyboard, mouse, external storage device (e.g., hard disk drive), and mobile device (e.g., smartphone or tablet). Electronics (e.g., computing systems) also generally employ one or more electrical couplings (e.g., wired connections) to facilitate the transmission and reception of data (e.g., communication) within a device (e.g., inter-chip communications).

Certain electrical couplings (e.g., connections) include parallel conductors (e.g., parallel wires or other electrically conductive paths). One embodiment of an electrical connection is a bus. One embodiment of a bus is a multiple conductor bus, for example, where the conductors (e.g., wires) allow parallel (e.g., concurrent) transmittal of data thereon. The term electrical coupling may generally refer to one or more connections, communication lines and/or interfaces, shared connections, and/or point-to-point connections, which may be connected by appropriate bridges, hubs, adapters, and/or controllers. A serial bus (e.g., serial bus architecture) may generally refer to a (e.g., shared) communication channel that transmits data one bit after another (e.g., sequentially), for example, over a (e.g., each) channel (e.g., single wire or fiber).

The phrase Universal Serial Bus (USB) generally refers to a specification(s) for a serial bus that supports the transmission and reception of data (e.g., and power and/or control) between a downstream facing port (e.g., a host) and an upstream facing port (e.g., device), for example, through one or more hubs there between. In one embodiment, a USB specification is the USB 2.0 (e.g., USB2) specification released on Apr. 27, 2016 and Engineering Change Notices approved through Mar. 25, 2016. In one embodiment, a USB specification is the USB 3.1 specification released on Jul. 26, 2015 and Engineering Change Notices approved through Sep. 12, 2016. In one embodiment, a USB circuit (e.g., protocol layer thereof) communicates according to a first protocol.

The phrase embedded Universal Serial Bus (eUSB) generally refers to a specification(s) for a serial bus that supports the transmission and reception of data (e.g., and power and/or control) between a downstream facing port (e.g., a host) and an upstream facing port (e.g., device), for example, at a lower signal voltage than a USB specification. In one embodiment, in contrast to USB, eUSB provides one or more of: Input/Output (10) power efficiency (e.g., to improve both the link active and idle power efficiency, process scalability (for example, to provide a low voltage USB (e.g., USB2.0) physical layer circuit (PHY) solution to lower the 3.3V IO signaling requirement, e.g., to a maximum of about 1.0V), implementation simplicity (for example, to reduce the PHY analog content) and support both USB (e.g., USB2.0) inter-chip and out-of-the-box devices. In one embodiment, an eUSB device communicates with an USB device through a separate circuit referred to generally as a repeater, e.g., the eUSB device and the USB device are not electrically compatible.

Certain embodiments herein provide for an adapter circuit (e.g., not a repeater) to couple a first USB (not eUSB) circuit (e.g., protocol layer thereof) that is to communicate according to a first protocol and a second eUSB circuit (e.g., analog front end thereof) that is to communicate according to a second, different protocol. Certain embodiments herein provide for an adapter circuit (e.g., not a repeater) to couple an embedded Universal Serial Bus (eUSB) circuit to a Universal Serial Bus (USB) transceiver interface circuit. In certain embodiments, a transceiver interface circuit communicates according to USB (e.g., USB 2.0) Transceiver Marcocell Interface (UTMI) specification, for example, the USB 2.0 Transceiver Macrocell Interface (UTMI) specification, version 1.05, of Mar. 29, 2001 or the UTMI+ specification, revision 1.0, of Feb. 25, 2004. In one embodiment, all circuits are within one device, e.g., as part of an interconnect of that device. Certain embodiments herein provide for an eUSB adapter layer for USB architecture designs.

In one embodiment, an eUSB specification defines to cater for future generation USB solutions where a host communicates to a device using a repeater (e.g., a re-driver and/or retimer) or through an eUSB device for embedded application. An eUSB PHY may include an analog front end circuit (e.g., to communicate with a separate device) and a logic layer circuit to communicate with a USB controller. Logic layer circuit may include serial interface engine (SIE) and/or data recover circuit (DRC). SIE may include a parallel-in data to serial-out data (PISO) converter and a serial-in data to parallel-out data (SIPO) converter. Controller may be a USB (e.g., USB2) controller, e.g., of a device. A USB (e.g., USB2) PHY interface may include a USB controller using transceiver interface (UTMI+) circuit, but in order to support an eUSB PHY protocol and keep USB (e.g., USB2) controller interface same, certain embodiments herein provide a novel circuit (e.g., circuit layer) to act as an interface between transceiver interface (UTMI+) circuit and an eUSB2 analog front end.

Certain embodiments herein provide for an adapter circuit to provide one or more of the following: control (e.g., high speed (HS)) transmittal and/or (e.g., HS) reception of serial communication to or from a (e.g., analog) front end circuit, reflect legacy USB (e.g., USB2) connection to UTMI+ (e.g., when eUSB connect handshake is detected), manage handshake to determine host/device operation with a repeater, convert legacy USB (e.g., USB2) port reset connection to eUSB2 port reset protocol, convert full speed (FS, e.g., 12 Mbits/s) and/or low speed (LS, e.g., 1.5 Mbits/s) transmittal of data and end of packet (EOP) data to eUSB2 single-ended data, detects eUSB2 disconnect through one (e.g., PING) protocol and converts to a different (e.g., UTMI) protocol, and manage Link layer power management.

Certain embodiments herein provide for one or more of the following: a quick turnaround time for development (e.g., to save significant development costs), implementation with a lower gate count, retain and reused UTMI+ logic layer circuit with a controller (e.g., without developing a new logic layer), add no or minimal latency in transmission and reception data paths, manage (e.g., all) link layer power management scenarios, provide a modular architecture and implement for multi-lane topology, simpler clocking and reset solutions, and retain all the side band or guest side band interfaces.

Certain embodiments herein allow for one or more of the following (for example, for a downstream facing device (e.g., host) and/or an upstream facing device (e.g., device of a host and device set)): reusing transceiver interface circuit (e.g., UTMI+ logic layer) and adding adapter logic in between analog front end circuit to reduce validation and development effort, provide for a robust architecture that maintains UTMI+ and the controller circuit (e.g., interface) remain same, provide for a modular design, e.g., to implement for multiple lane application, provide for a more efficient power management scheme, e.g., to provide a low power solution, and to lower the gate counts in the circuitry.

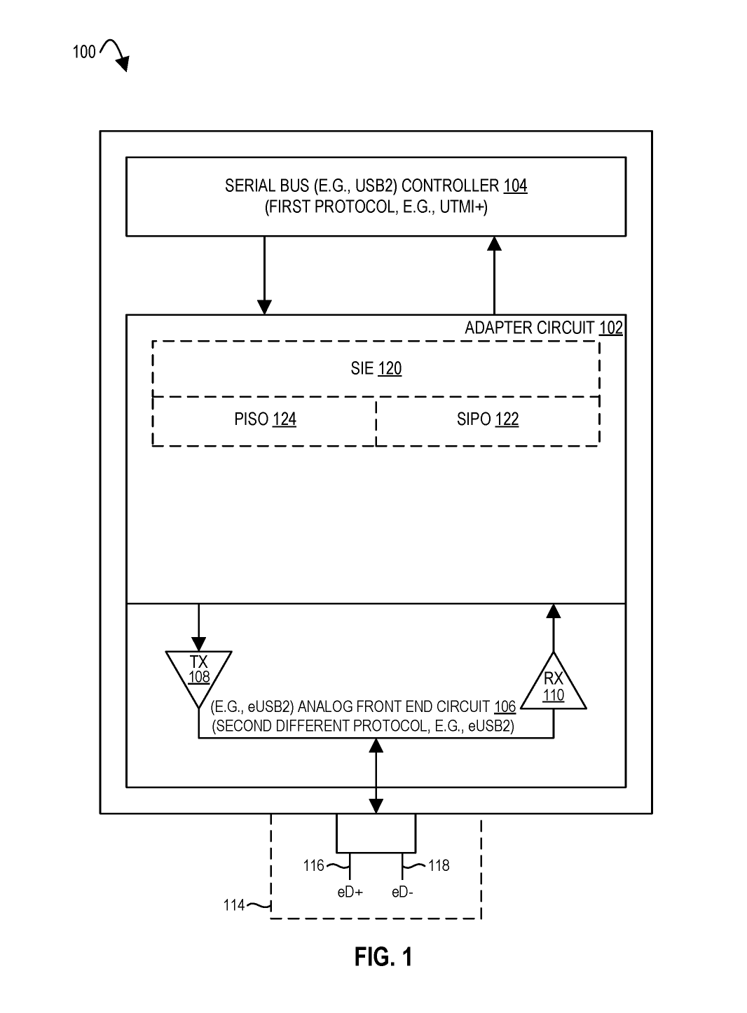

Turning now to the figures, FIG. 1 illustrates a schematic diagram of a serial bus (e.g., USB) circuit 100 including an adapter circuit 102 according to embodiments of the disclosure. In one embodiment, serial bus circuit 100 is a part of a system (e.g., discussed below). Analog front end circuit 106 includes a transmitter (TX) 108 to transmit data from serial bus circuit (e.g., device including the serial bus circuit) to a component or other device and a receiver (RX) 110 to receive data from a component or other device. Analog front end may include a pair of eUSB (e.g., eUSB) data lines 114 (e.g., of a port or receptacle), referred to herein as eD+ 116 and eD−118. The data lines are used to transmit signals between an upstream facing port and a downstream facing port, e.g., where the downstream port faces downstream and the upstream port faces upstream. Depending on the particular operating mode, the analog front end circuit 106 is to transmit data on the data lines 114 using differential signaling, single ended communications, or some combination thereof. For example, while operating in high speed, differential signaling may be used to transmit data, while single-ended communications may be used to transmit control signals. While operating in low speed or full speed, single-ended communications may be used to transmit data and control signals (e.g., on eD+/eD− lines single ended). For example, an eD− line having data and an eD+ line (of a corresponding pair of lines) being idle may indicate full speed (FS) and the eD+ line having data and the eD− line being idle may indicate low speed (LS). The functions and behaviors of eD− and eD+ may vary depending on the data rate of the device. Analog front end circuit 106 may include any number of transmitters and receivers for controlling the signals lines 114. A single transmitter 108 and receiver 110 pair are shown in FIG. 1. However, it will be appreciated that any suitable number of transmitters and receivers may be used to implement the various embodiments described herein.

Serial bus circuit 100 (e.g., adapter circuit 102) may include a serial interface engine (SIE) for translating USB information packets, e.g., to be used by a protocol layer. Depicted Serial Interface Engine 120 includes a serial-in, parallel-out (SIPO) converter 122 for converting incoming serial data received via the signal lines 114 into parallel data for transmitting (for example, to the controller, e.g., to a link layer thereof). The Serial Interface Engine 120 also includes a parallel-in, serial-out (PISO) converter 124 for converting outgoing parallel data received (e.g., from a link layer) into serial data for transmission onto the signal lines 114.

Serial bus circuit 100 further includes a serial bus (e.g., USB2) controller 104. Serial bus controller 104 may include a transceiver interface circuit (e.g., communicating according to the UTMI or UTMI+ protocol). Serial bus controller 104 may manage the requests and other data from a system including serial bus circuit 100. For example, controller 104 may be responsible for controlling data packet transfers (e.g., transfer initiation), suspend and resume initiation, bus speed control (e.g., HS, FS and LS) and interacting with the analog front end circuit 106 for facilitating data communications.

Adapter circuit 102 (e.g., as part of an eUSB PHY circuit) is coupled between controller 104 and analog front end circuit 106. In one embodiment, adapter circuit is to convert between (e.g., to and/or from) a first protocol (e.g., eUSB) of the analog front end circuit and a second, different protocol (e.g., UTMI+) of the controller (e.g., a transceiver interface circuit thereof), for example, in addition to an SIE functions (e.g., SIPO or PISO conversions).

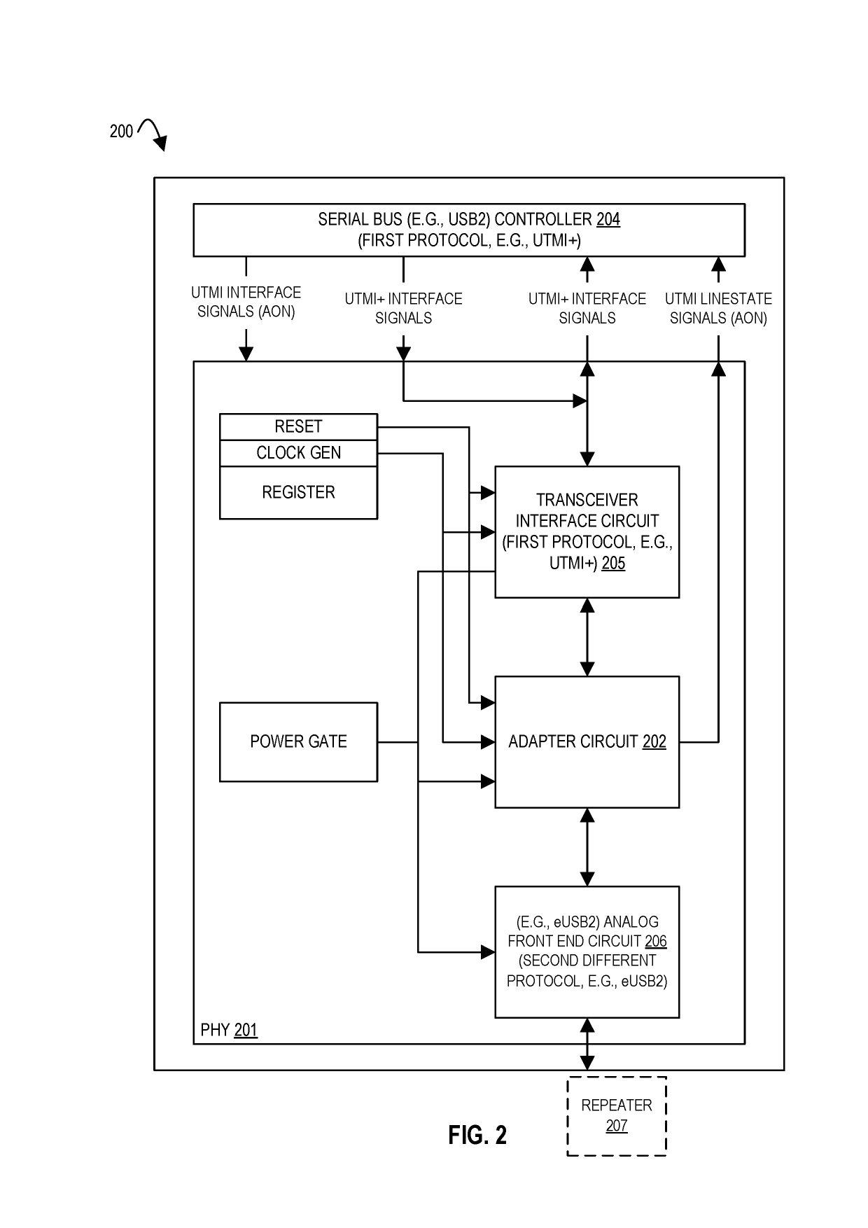

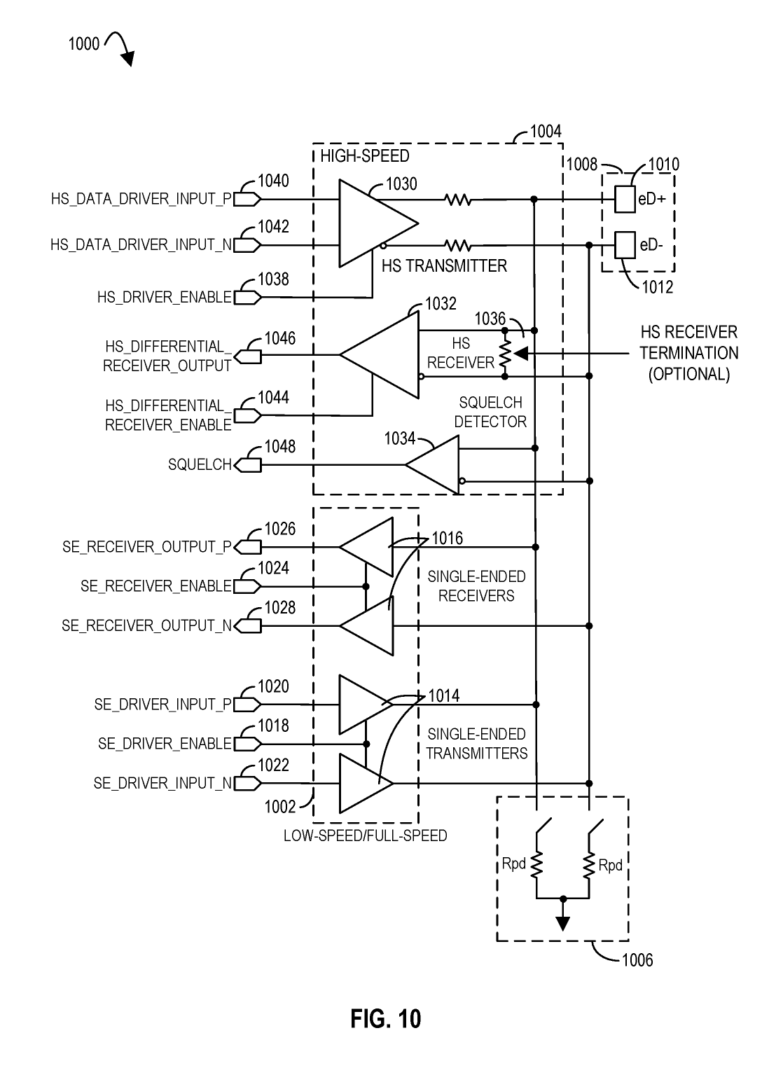

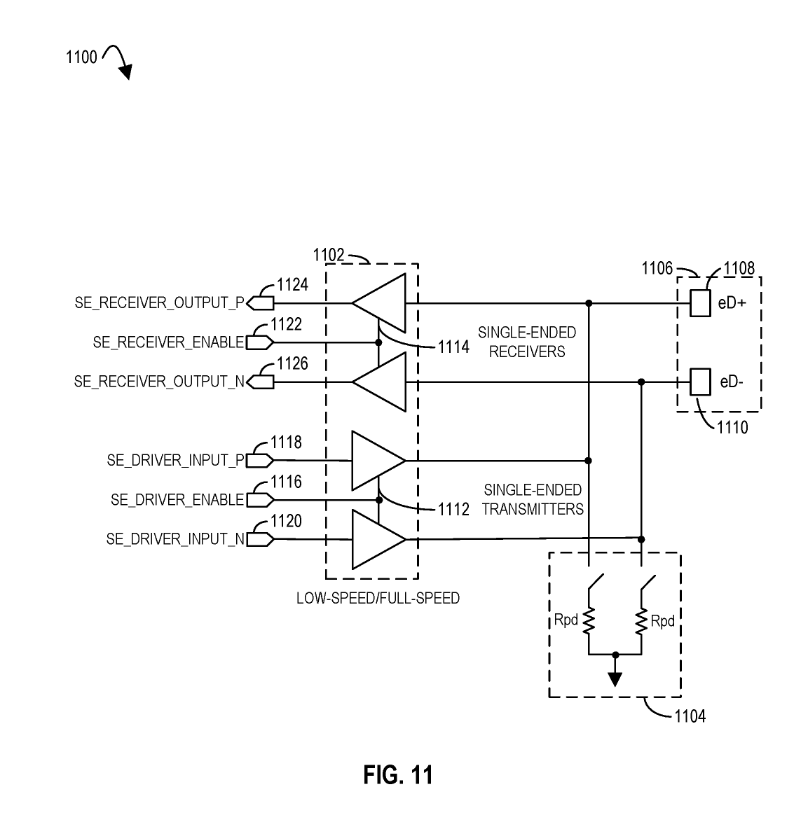

FIG. 2 illustrates a schematic diagram of a serial bus circuit 200 including an adapter circuit 202 according to embodiments of the disclosure. Adapter circuit 202 is coupled between transceiver interface (e.g., UTMI+) circuit 205 and analog front end circuit 206. In one embodiment, adapter circuit is to convert between (e.g., to and/or from) a first protocol (e.g., eUSB) of the analog front end circuit and a second, different protocol (e.g., UTMI or UTMI+) of the controller and/or transceiver interface circuit. Depicted transceiver interface circuit 205 may be a separate circuit as shown or a part of serial bus controller 204. In one embodiment, analog front end circuit includes the circuitry in FIG. 10 or 11, for example, with the adapter circuit included when the analog front end circuit is an eUSB circuit (e.g., as in FIG. 10 or 11), but not included (or utilized) when the analog front end circuit is a different USB circuit.

In one embodiment, adapter circuit 202 receives (e.g., serial) to-be-transmitted data from transceiver interface (e.g., UTMI+) circuit 205 and forwards that data onward via analog front end circuit 206, e.g., to an optional repeater 207 connected to analog front end circuit 206). Adapter circuit 202 may receive (e.g., serial) data and send that data back to transceiver interface (e.g., UTMI+) circuit 205.

In certain embodiments, an adapter circuit provides one or more of the following: manage a new top to bottom configuration handshake to determine host and/or device operation with an attached repeater 207, which may be referred to as TBConfig herein, reflect (indicate) a legacy USB (e.g., USB2) connection to the transceiver interface (e.g., UTMI+) circuit 205 when a (for example, eUSB, e.g., eUSB2) connect handshake is detected, converts legacy USB (e.g., USB2) port reset connection to a different (e.g., eUSB) port reset protocol, convert classic (differential pair) (e.g., full speed) transmittal data and end of packet (EOP) indication to eUSB2 single-ended data (e.g., an eD− line having data and an eD+ line (of a corresponding pair of lines) being idle to indicate full speed (FS) and the eD+ line having data and the eD− line being idle to indicate low speed (LS)), detect (e.g., eUSB2) high speed disconnect through PING protocol and convert to UTMI protocol, and handle the (e.g., eUSB2) line state and perform filtering and send the USB2 line-state signals to transceiver interface (e.g., UTMI+) circuit based on lane activity. In one embodiment, TBConfig is a way to communicate whether an Attachment (Attach) event is host driven or repeater driven. TBConfig may provide an indication or handshake where the host and repeater has information which indicates which party is responsible for Attach event indication.

In one embodiment, a pair of single-ended logic ‘1’ signals (SE1) is used during eUSB2 operations to issue control messages. As discussed above, eUSB (e.g., eUSB2) specification provides an input/output (I/O) solution that reduces the voltage cost and power consumption of USB 2.0 interfaces. For example, eUSB2 uses 1.0 Volt (V) signaling rather than the 3.3 Volt signal in USB 2.0 Low-Speed (LS) and Full-Speed (FS) operations. Additionally, eUSB2 uses a 0.2 V differential signaling instead of the 0.4 V differential signaling for USB 2 High-Speed (HS) interfaces. Due to the differences in the signal strength of USB2 and eUSB2, an eUSB2 repeater 207 may be used as an electrical bridging solution to ensure that these two USB2 and eUSB2 are compatible with one another. Depicted “UTMI interface signals (AON)” may be an always on signal (AON) which provides an indication to physical layer circuit (PHY) 201 irrespective of the power gated domain. Depicted “UTMI+ interface signals” may include one or more of UTMI data in (e.g., [7:0]), UTMI data out (e.g., [7:0]), Termination (Term) select (for example, to select between different resistive values (resistors), e.g., a different value for FS termination and a HS termination)), Transceiver select (XCVRselect) (for example, to select between different transceivers, e.g., a FS transceiver and a HS transceiver), TX valid, TX ready, RX active, RX valid, RX error, other UTMI+ defined controls signals, and Linestate (e.g., [1:0]) (e.g., signals that reflect (indicate) the current state of the single ended receivers). Depicted “UTMI linestate signals (AON)” may be always on asynchronous signals which is running on Power supply always on domain, e.g., gives a wake indication even when circuitry (e.g., a PHY 201 transmitter data path) is powered down.

A USB system (e.g., USB2 host or device system) may include circuitry (e.g., a PHY transmitter data path) that, apart from the powered down portions, are in an “always on” (AON) domain and when the remote wake is detected, limited retention registers, also in an always on domain, may be used to reflect a resume-K signal, while a normal power-up calibration may be done in the background,. The USB2 PHY may thus be placed in an ultra-deep power mode and then enabled, e.g., after getting indication of wake-on connect.

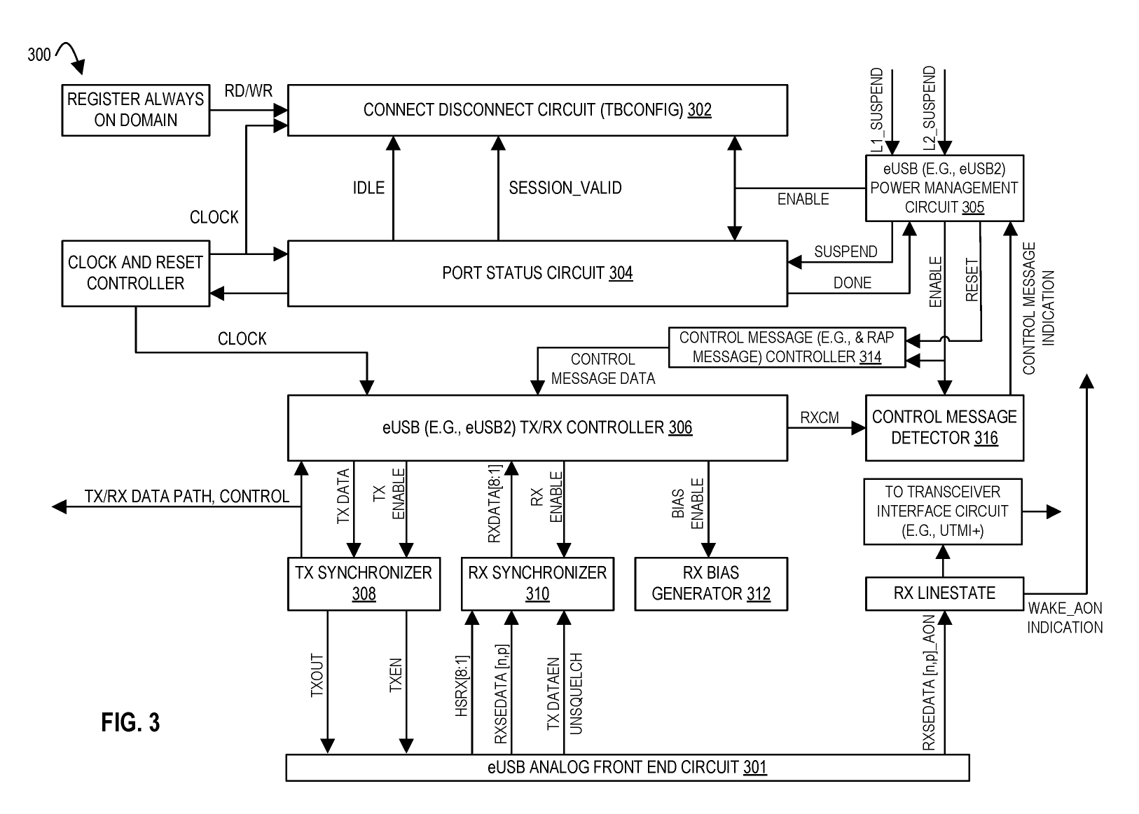

FIG. 3 illustrates a schematic diagram of an adapter circuit 300 coupled to an eUSB (e.g., eUSB2) analog front end circuit 301 according to embodiments of the disclosure. Adapter circuit 300 illustrate the various data signals that may be sent to and/or from each circuitry block. Connect/disconnect (TBConfig) block 302 may manage (e.g., the connection and disconnection) for a USB (e.g., USB2) connection, e.g., either through a repeater initiated connection or through a system (e.g., system on a chip (SOC)) initiated connection. Port reset circuit 304 may manage USB (e.g., USB2) ports reset related signaling for example, handling chirp and USB port reset signaling. eUSB (e.g., eUSB2) power management circuit 305 may manage eUSB state (e.g., L0 and L1/L2) suspend, entry, and exit and/or low power mode preparation and exit for each data lane (e.g., of a plurality of data lanes). eUSB Power management circuit 305 may send a power state indication (e.g., enable) to generate a control message (e.g., receiver control message (RXCM)) through control message generator 314. eUSB (e.g., eUSB2) transmitter (TX)/receiver (RX) controller 306 may manage TX and RX transactions and data path control (e.g., selection) of different USB speeds. Control message detector 316 may be responsible for decoding control message received from eUSB front end circuit (e.g., from repeater 207 in FIG. 2); which may have information of USB (e.g., D+/D−) suspend/Resume/reset states indications. eUSB power management circuit 305 may decide the current power state after getting a control message indication from control message detector 316.

TX (e.g., eUSB2 TX) synchronizer 308 may synchronize TX data in and data out and control the data path utilized, e.g., according to an eUSB specification. RX (e.g., eUSB2 RX) synchronizer 310 may synchronize RX data in and data out and control the data path utilized, e.g., according to an eUSB specification. RX (e.g., eUSB2 RX) bias generator 312 may generate the desired bias (e.g., voltage and current biases required for RX circuits and/or providing a pull-up and/or pull-down resistive value (resistors)), e.g., according to an eUSB or USB specification. eUSB (e.g., eUSB2) control message controller 314 may encode and decode control message information (e.g., according to the register access protocol (RAP)) that is transmitted and received (e.g., to a repeater).

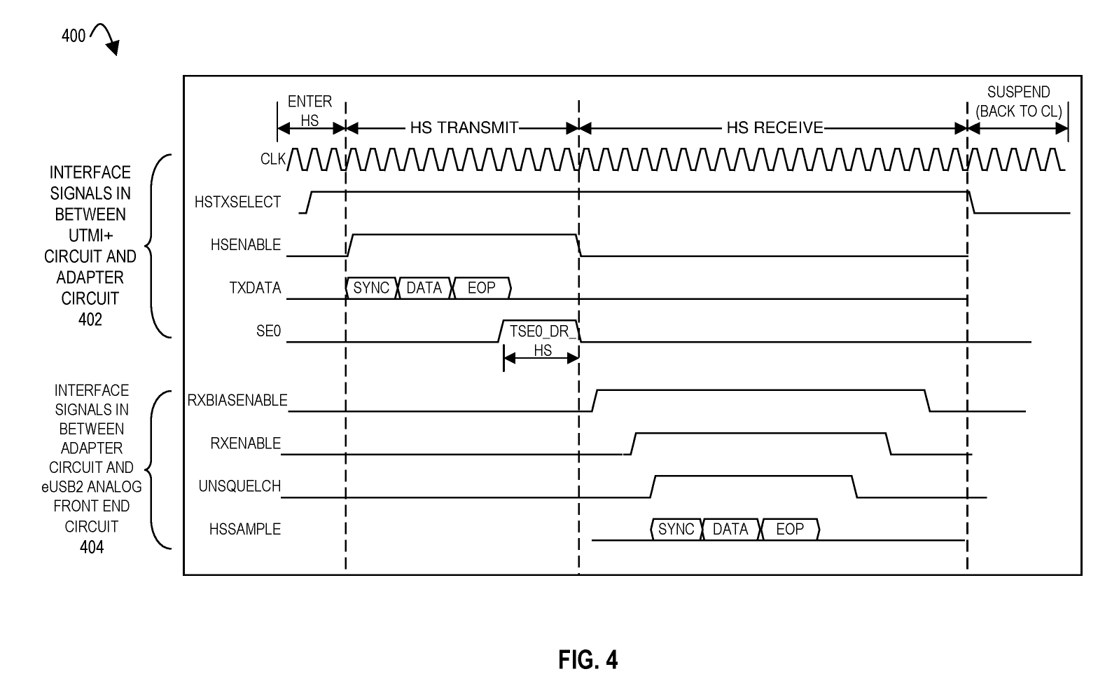

FIG. 4 illustrates a high speed (HS) transmit and high speed (HS) receive timing diagram 400 of a serial bus circuit including an adapter circuit according to embodiments of the disclosure. In the depicted embodiment, 402 illustrates the interface signals between a transceiver interface (e.g., UTMI+) circuit (e.g., transceiver interface circuit 205 or transceiver interface circuit of controller 104) and an adapter circuit (e.g., adapter circuit 202, adapter circuit 300, or adapter circuit 102). In the depicted embodiment, 404 illustrates the interface signals between an (e.g., eUSB) analog front end circuit (e.g., analog front end circuit 106, analog front end circuit 206, analog front end circuit 1000, or analog front end circuit 1100) and an adapter circuit (e.g., adapter circuit 202, adapter circuit 300, or adapter circuit 102). SE0 may refer to a single ended zero signal. CL may refer to classic (e.g., full or low) speed of data transmittal and/or reception. TSE0_DR_HS may refer to the amount of time (e.g., 20-70 ns) that an active driver shall release driving SE0 from non-SE0 to SE0, before letting the weak pull-down hold the wire in SE0 idle. Unsquelch may refer to de-assertion of squelch signal indication from a squelch detector, e.g., the squelch detector in FIG. 11.

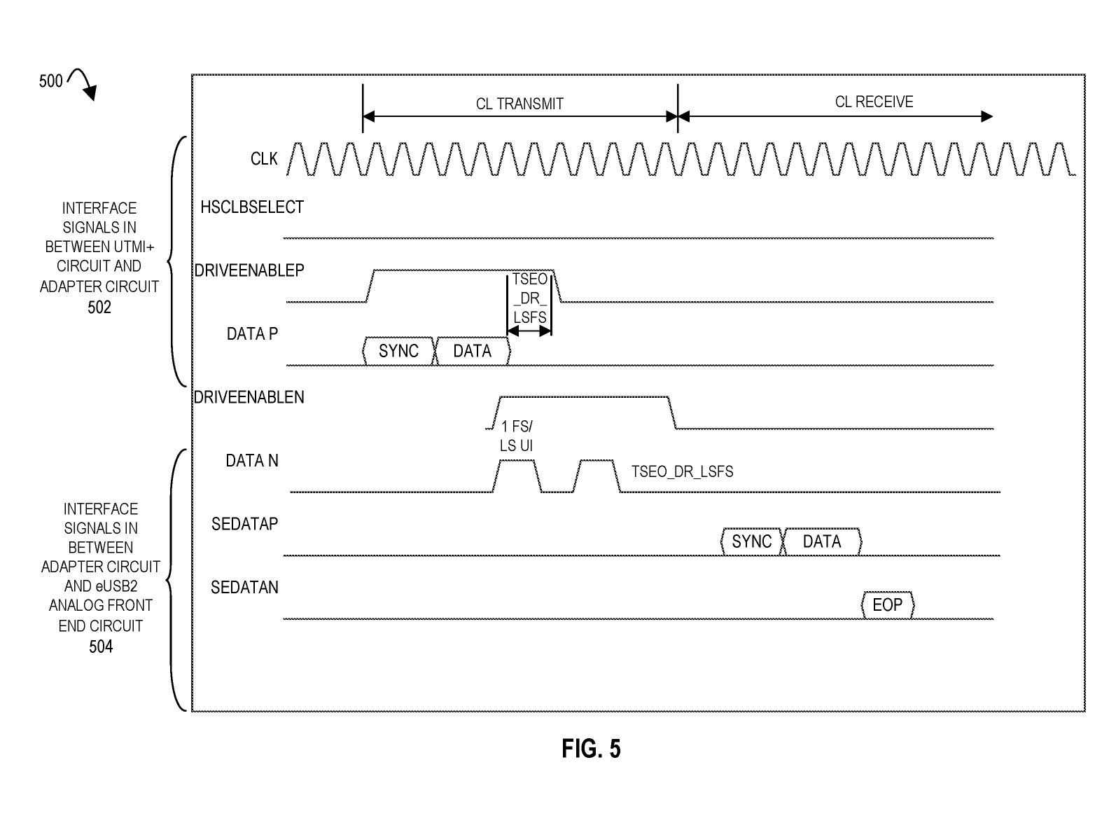

FIG. 5 illustrates a classic (CL) (e.g., full or low) speed transmit and classic (CL) (e.g., full or low) speed receive timing diagram 500 of a serial bus circuit including an adapter circuit according to embodiments of the disclosure. In the depicted embodiment, 502 illustrates the interface signals between a transceiver interface (e.g., UTMI+) circuit (e.g., transceiver interface circuit 205 or transceiver interface circuit of controller 104) and an adapter circuit (e.g., adapter circuit 202, adapter circuit 300, or adapter circuit 102). In the depicted embodiment, 504 illustrates the interface signals between an (e.g., eUSB) analog front end circuit (e.g., analog front end circuit 106, analog front end circuit 206, analog front end circuit 1000, or analog front end circuit 1100) and an adapter circuit (e.g., adapter circuit 202, adapter circuit 300, or adapter circuit 102). TSE0_DR_LSFS may refer to the amount of time (e.g., 20-70 ns) that an active driver shall continue to drive the wire to transition from non-SE0 to SE0, before letting the weak pull-down to hold the wire in SE0 idle, for low-speed and full-speed mode. Positive (P) may be the eD+ data line, for example, data P (DATAP) being set (e.g., high) may indicate data being driven on the eD+ data line. Negative (N) may be the eD− data line for example, data N (DATAN) being set (e.g., high) may indicate data being driven on the eD− data line. UI may refer to a unit interval of time, e.g., according to a clock. SEDATAP may refer to single ended data (positive). SEDATAN may refer to single ended data (negative).

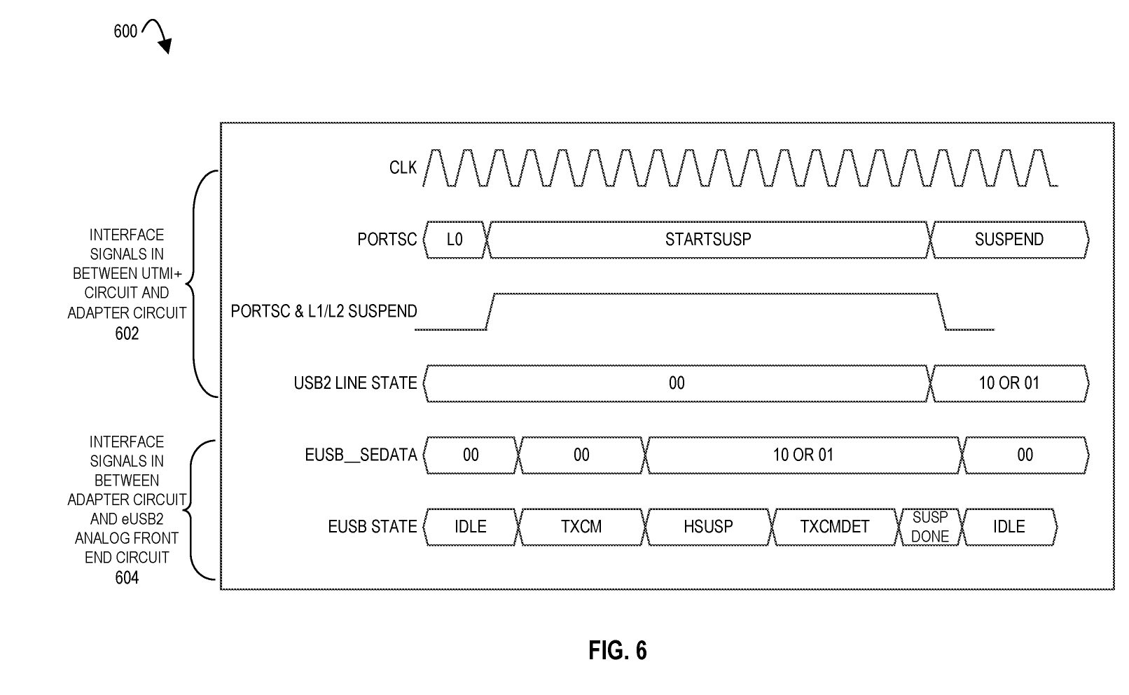

FIG. 6 illustrates a state timing diagram 600 of a serial bus circuit including an adapter circuit according to embodiments of the disclosure. In particular, state timing diagram 600 is an embodiment of the adapter circuit states sent to the transceiver interface circuit during a (e.g., L0) link state. In the depicted embodiment, 602 illustrates the state signals between a transceiver interface (e.g., UTMI+) circuit (e.g., transceiver interface circuit 205 or transceiver interface circuit of controller 104) and an adapter circuit (e.g., adapter circuit 202, adapter circuit 300, or adapter circuit 102). In the depicted embodiment, 604 illustrates the state signals between an (e.g., eUSB) analog front end circuit (e.g., analog front end circuit 106, analog front end circuit 206, analog front end circuit 1000, or analog front end circuit 1100) and an adapter circuit (e.g., adapter circuit 202, adapter circuit 300, or adapter circuit 102). SUSP may refer to suspend. SC may refer to a session controller, e.g., PORTSC being a port session controller. USP may refer to an upstream port, e.g., HSUSP being a high speed upstream port. CMDET may refer to a control message detector, e.g., the control message detector 316 in FIG. 3. A data signal of XY (e.g., 01) may refer to an X signal (e.g., zero for 01) on a first port (e.g., eD+) and a Y signal (e.g., one for 01) on a second port (e.g., eD−). A logical one may be about 1V for a signal according to an eUSB specification.

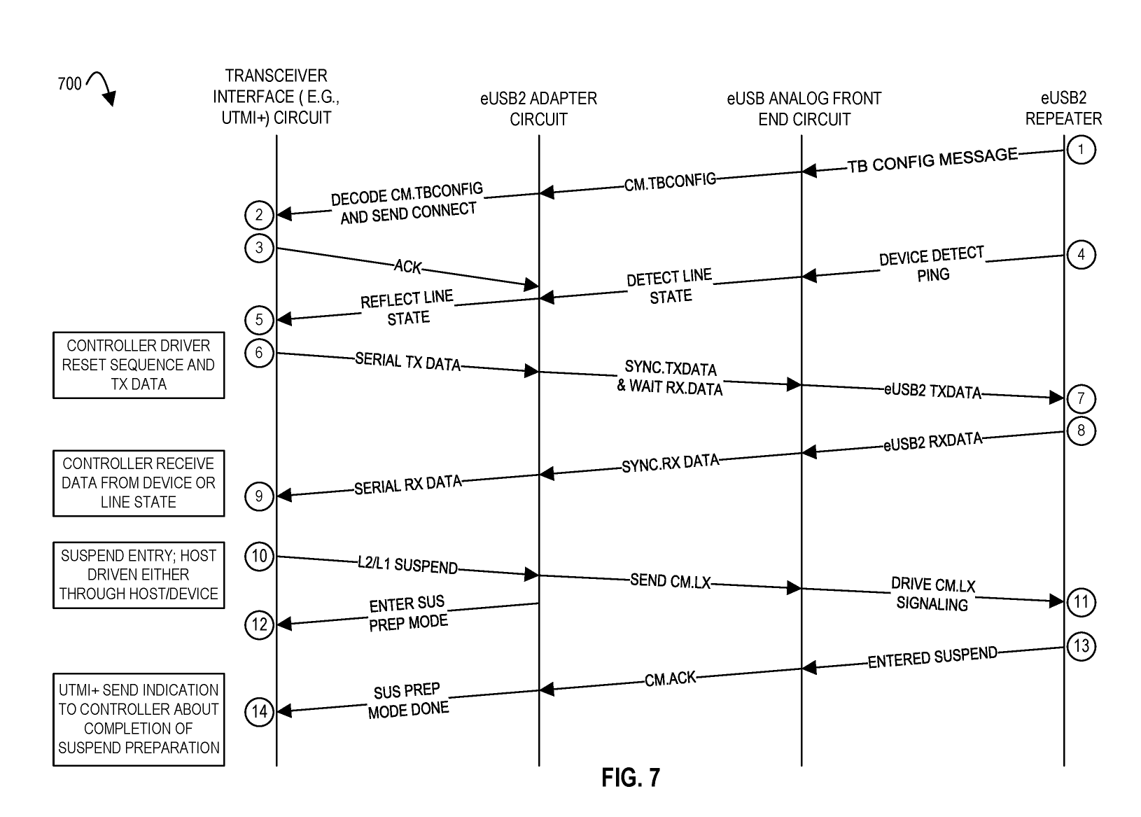

FIG. 7 illustrates a flow diagram 700 for a serial bus circuit including an adapter circuit according to embodiments of the disclosure. In particular, flow diagram 700 depicts an embodiment of entry to an active (e.g., L0) state (e.g., numbers 1-9 in FIG. 7) and entry to a suspend (e.g., L2) state (e.g., numbers 10-14 in FIG. 7) for a serial bus circuit comprising a repeater connected to an analog front end circuit connected to an adapter circuit connected to a transceiver interface circuit, e.g., and the signals between each of those components listed accordingly. For example, an arrow into the line representing the adapter circuit is to indicate the signals entering and exiting the adapter circuit. In one embodiment, during L0, adapter circuit is to decode the message from repeater or send indication of wake to transceiver interface (e.g., UTMI+) circuit using line-state indication. Handshaking between transceiver interface (e.g., UTMI+) circuit and adapter circuit are is shown as a high level flow. Port reset and TX/RX data path are controlled by adapter circuit during the depicted L0 operation. In one embodiment, during L2 suspend (e.g., whether driven from host or device), adapter circuit is to enter into a lower (e.g., Low) power preparation mode and once it is in low power mode, the state is complete. Adapter circuit may send indication back to transceiver interface (e.g., UTMI+) circuit to indicate low power mode preparation is complete by sending a complete indication.

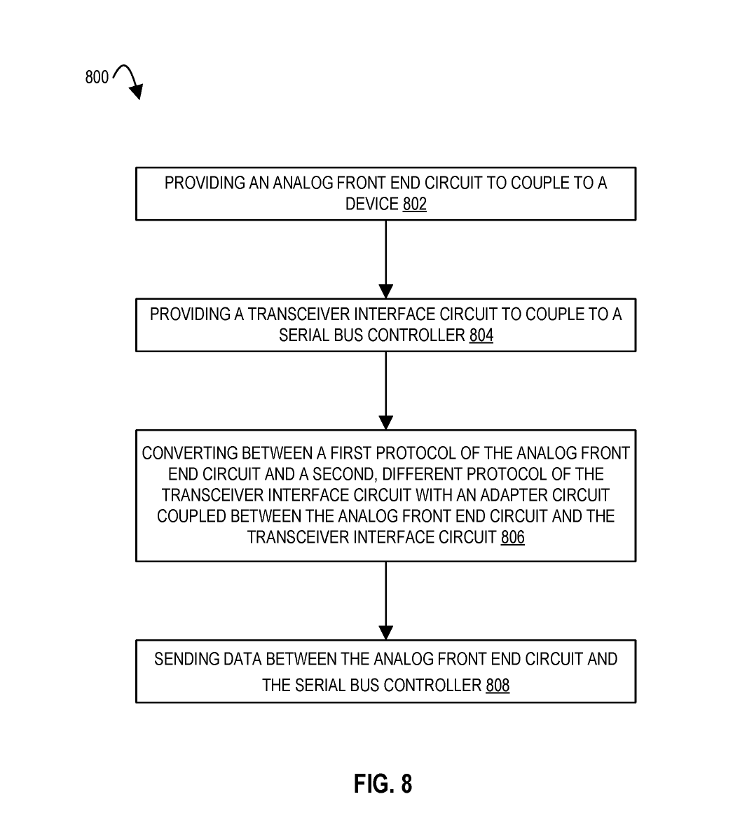

FIG. 8 illustrates a flow diagram 800 for a serial bus circuit including an adapter circuit according to embodiments of the disclosure. Depicted flow includes providing an analog front end circuit to couple to a device 802; providing a transceiver interface circuit to couple to a serial bus controller 804; converting between a first protocol of the analog front end circuit and a second, different protocol of the transceiver interface circuit with an adapter circuit coupled between the analog front end circuit and the transceiver interface circuit 806; and sending data between the analog front end circuit and the serial bus controller 808.

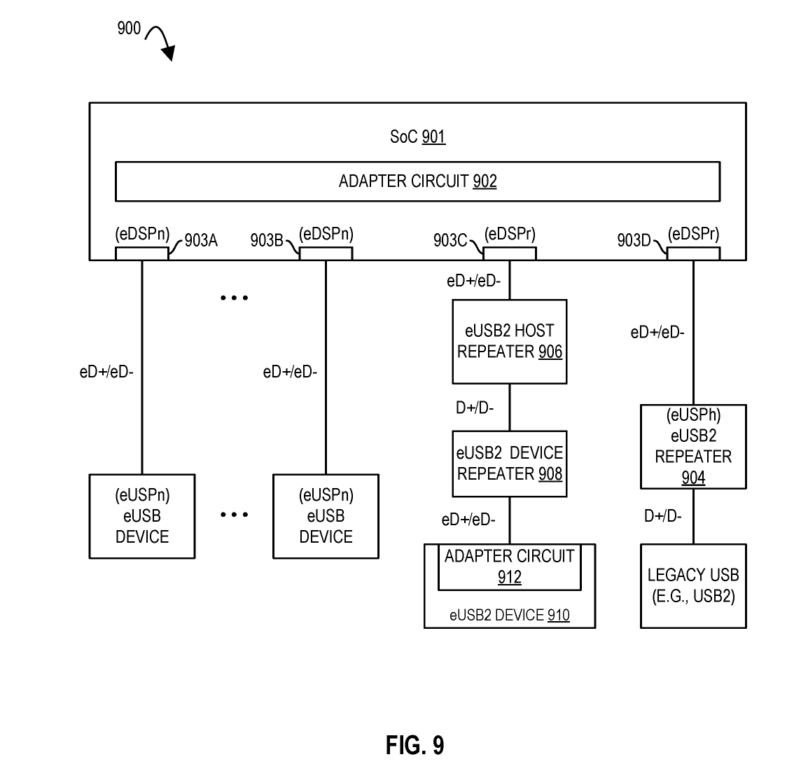

FIG. 9 illustrates a schematic diagram of a serial bus circuit 900 including an adapter circuit 902 coupled to a repeater circuit 904 (e.g., a re-driver and/or retimer) according to embodiments of the disclosure. System on a chip (SoC) 901 may include an adapter circuit 902, e.g., to couple SoC's USB controller (e.g., a transceiver interface circuit thereof) to an analog front end circuit 903A-903D. eDSPn may refer to a downstream eUSB2 port in native mode. EUSPh may refer to an upstream eUSB2 port of a host repeater. eDSPr may refer to an upstream eUSB2 port in repeater mode. D+/D− according to USB specification. D+ may refer to positive about 3.3V and D− may refer to negative about 3.3V. eD+ may refer to positive about 1V, e.g., according to eUSB specification. eD− may refer to negative about 1V, e.g., according to eUSB specification. Analog front end circuit 903C is coupled to an eUSB2 host repeater 906, which is coupled to an eUSB2 device repeater 908, which is coupled to an eUSB device 910, e.g., via adapter circuit 912. In one embodiment, adapter circuit 912 is an adapter circuit according to this disclosure, e.g., such that there is an adapter on a first (e.g., host) device and an adapter circuit in a second (e.g., device of a host and device pair) device.

FIG. 10 illustrates an (e.g., eUSB) analog front end circuit 1000 according to embodiments of the disclosure. Analog front end circuit 1000 includes High-Speed (HS), Low-Speed (LS), and Full-Speed (FS) capability. In embodiments, the HS, FS, and LS data rates correspond to the data rates specified by the USB2 specification. For example, during LS operation the analog front end circuit may provide a data rate of approximately 1.5 Mbit/s, during FS operation the analog front end circuit may provide a data rate of approximately data rate of 12 Mbit/s, and during HS operation, the analog front end circuit may provide a data rate of approximately 480 Mbit/s. The eUSB2 analog front end circuit 1000 may include both a Low-Speed/Full-Speed (LS/FS) transceiver 1002 and a High-Speed (HS) transceiver 1004. In embodiments, the analog front end circuit 1000 also includes a pair of pull-down resistors 1006 used for device connect detection. The LS/FS transceiver 1002 and HS transceiver 1004 are communicatively coupled to the eUSB2 signal lines 1008, which include eD+ 1010 and eD− 1012. The HS transceiver 1004 and LS/FS transceiver 1002 may selectively take control of the signal lines 1008 depending on the data rate capabilities of the upstream device connected to the analog front end circuit 1000. Techniques for determining the data rate capabilities of the upstream device are described further below.

The LS/FS transceiver 1002 may include a pair of single-ended transmitters 1014 and a pair of single-ended receivers 1016. These components act as the input and output, respectively, for single-ended signaling. In single-ended signaling, each of the signal lines eD+ 1010 and eD− 1012 may transmit separate signal information. This is in contrast to USB (e.g., USB2) implementation, in which LS/FS operations use differential signaling. In differential signaling, information is transmitted through two complementary signals transmitted on the pair of signal lines eD+ 1010 and eD− 1012. The translation of the physical signals transmitted over the signal lines 1008 into binary signal data may be accomplished using any suitable techniques, such as Non-return-to-zero, inverted (NRZI).

The single-ended transmitters 1014 and the single-ended receivers 1016 may be components that operate with a signaling voltage of 1.0 Volt, as compared to the 3.3 Volt signaling for USB2. Low-speed/Full-speed idle state (SE0) is maintained by the pull-down resistors 1006 implemented at the downstream port. To ensure a swift transition to idle state, the port shall drive the bus to SE0 before disabling its transmitters.

The HS transceiver 1004 may be an analog transceiver for low swing differential signaling. For example, the HS transceiver may operate with a signaling voltage of 0.2 Volts, as compared to the 0.4 Volts used in USB2, thus a reduced power consumption is achieved during data transmission. The HS transceiver 1004 may include a High-Speed transmitter 1030 for data transmission, a High-Speed receiver 1032 for data reception, and a squelch detector 1034 for detection of link status, i.e. HS active, and HS idle. Additionally, in some embodiments, the HS transceiver 1004 may also include an HS receiver termination 1036 to minimize the signal reflection at the receiver leading to improved signal integrity. During the HS operating mode, wherein the HS transceiver 1004 is enabled, the analog front end circuit 1000 communicates data using differential signaling and may also transmit control signals using single-ended communications.

The HS transceiver 1004 and LS/FS transceiver 1002 are both controlled by a controller (not shown), which interfaces with the analog front end circuit 1000. Various data and control lines are coupled to the transceivers 1002 and 1004. For example, as shown in FIG. 10, enable signals 1018, 1024, 1044, and 1038 are used to selectively enable the LS/FS transmitters 1014, the LS/FS receivers 1016, the HS receiver 1032, or the HS transmitter 1030, respectively. Complementary driver inputs 1040 and 1042 are coupled to the HS transmitter 1030 for driving the HS transmitter to output data and/or control signals to the signals lines 1008. A receiver output 1046 is coupled to the HS receiver 1032 for receiving data transmitted to the analog front end circuit 1000 via the signals lines 1008. A squelch detector 1048, upon detecting the start of HS data packet, disables the SE receiver 1016, enables the HS receiver 1032, and optionally the receiver termination 1036. Positive and negative receiver outputs 1026 and 1028 are coupled to the LS/FS receivers 1016 for receiving data transmitted to the analog front end circuit 1000 via the signals lines 1008. Positive and negative driver inputs 1020 and 1022 are coupled to the LS/FS transmitters 1014 for driving the LS/FS transmitter to output data and/or control signals to the signals lines 1008.

In embodiments, the device port (not shown) will have an eUSB interface with an analog front end circuit substantially similar to analog front end circuit 1000. In such an embodiment, the host and device both use the eUSB protocol. In embodiments, the device port may be a USB2 port with a USB2 physical layer. In such an embodiment, a repeater may be used to translate the eUSB signals sent from the host to USB2 signals. For example, the repeater may translate signals, such as device connect, device disconnect, data rate negotiation, and the like. The repeater may also be used to recondition the voltages of the eUSB signals to the voltages used in USB2.

FIG. 11 illustrates an (e.g., eUSB) analog front end circuit 1100 according to embodiments of the disclosure. Analog front end circuit 1100 includes Low-Speed or Full-Speed capability. As shown in FIG. 11, the eUSB2 analog front end circuit 1100 may include a single-ended transceiver 1102 without also including a High-Speed analog transceiver. It may function similarly to the eUSB analog front end circuit 1000 shown in FIG. 10, but does not have the capability to operate at High Speed (HS). The LS/FS analog front end circuit 1100 may include an SE transceiver 1102, a set of pull-down resistors 1104, and a pair of eUSB2 data lines 1106.

In one embodiment, an apparatus includes an analog front end circuit to couple to a device; a transceiver interface circuit to couple to a serial bus controller; and an adapter circuit coupled between the analog front end circuit and the transceiver interface circuit to convert between a first protocol of the analog front end circuit and a second, different protocol of the transceiver interface circuit. The adapter circuit may convert a disconnect indication for a disconnect from a higher speed of two speeds of data transmittal of the device between the first protocol and the second, different protocol. The adapter circuit may convert a speed selection indication between the first protocol and the second, different protocol to enable a data connection to the device in a higher speed of two non-zero speeds of data transmittal. The adapter circuit may convert data between a single ended transmitter format of the analog front end circuit according to the first protocol and a differential pair transmitter format of the transceiver interface circuit according to the second, different protocol. The adapter circuit may convert data between a single ended receiver format of the analog front end circuit according to the first protocol and a differential pair receiver format of the transceiver interface circuit according to the second, different protocol. The adapter circuit may further include a serial interface engine to convert parallel-in data to serial-out data and convert serial-in data to parallel-out data. The adapter circuit may convert a port reset indication between the first protocol of the analog front end circuit and the second, different protocol of the transceiver interface circuit. The first protocol may be an embedded Universal Serial Bus (eUSB) specification and the second, different protocol may be a USB Transceiver Macrocell Interface (UTMI or UTMI+) specification. The device may include a second analog front end circuit coupled to the analog front end circuit, the second analog front end circuit may be coupled to a second adapter circuit of the device that is coupled to a second transceiver interface circuit of the device, and the second adapter circuit may convert between a first protocol of the second analog front end circuit and a second, different protocol of the second transceiver interface circuit. The adapter circuit may convert a power state indication between the first protocol and the second, different protocol. The adapter circuit may convert a suspend indication between the first protocol and the second, different protocol to suspend data transmittal of the device. An adapter circuit may receive an indication in the second, different protocol from the transceiver interface circuit and in response the adapter circuit may generate a control signal indication in the first protocol, for example, sent by control message controller (e.g., control message controller 314 in FIG. 3), e.g., via eD+ and eD− lines. An adapter circuit may decode a received command code and send an according indication to the transceiver interface circuit. An adapter circuit may receive a suspend indication (e.g., from a repeater) and convert and send that indication back to the transceiver interface circuit (e.g., UTMI+) and may also send a control message indication to repeater before going into suspension.

In another embodiment, a method includes providing an analog front end circuit to couple to a device; providing a transceiver interface circuit to couple to a serial bus controller; converting between a first protocol of the analog front end circuit and a second, different protocol of the transceiver interface circuit with an adapter circuit coupled between the analog front end circuit and the transceiver interface circuit; and sending data between the analog front end circuit and the serial bus controller. The converting may include converting a disconnect indication for a disconnect from a higher speed of two speeds of data transmittal of the device between the first protocol and the second, different protocol. The converting may include converting a speed selection indication between the first protocol and the second, different protocol to enable a data connection to the device in a higher speed of two non-zero speeds of data transmittal. The converting may include converting data between a single ended transmitter format of the analog front end circuit according to the first protocol and a differential pair transmitter format of the transceiver interface circuit according to the second, different protocol. The converting may include converting data between a single ended receiver format of the analog front end circuit according to the first protocol and a differential pair receiver format of the transceiver interface circuit according to the second, different protocol. The method may further include converting parallel-in data to serial-out data and converting serial-in data to parallel-out data with a serial interface engine of the analog front end circuit. The converting may include converting a port reset indication between the first protocol of the analog front end circuit and the second, different protocol of the transceiver interface circuit. The first protocol may be an embedded Universal Serial Bus (eUSB) specification and the second, different protocol may be a USB Transceiver Macrocell Interface (UTMI or UTMI+) specification. The device may include a second analog front end circuit coupled to the analog front end circuit, and the second analog front end circuit may be coupled to a second adapter circuit of the device that may be coupled to a second transceiver interface circuit of the device, and the method may further include converting between a first protocol of the second analog front end circuit and a second, different protocol of the second transceiver interface circuit with the second adapter circuit. The converting may include converting data a power state indication between the first protocol and the second, different protocol. The converting may include converting a suspend indication between the first protocol and the second, different protocol to suspend data transmittal of the device.

In yet another embodiment, an apparatus includes a physical layer comprising an analog front end circuit to couple to a device; a transceiver interface circuit to couple to a serial bus controller; and an adapter circuit coupled between the analog front end circuit and the transceiver interface circuit to convert between a first protocol of the analog front end circuit and a second, different protocol of the transceiver interface circuit. The adapter circuit may convert a disconnect indication for a disconnect from a higher speed of two speeds of data transmittal of the device between the first protocol and the second, different protocol. The adapter circuit may convert a speed selection indication between the first protocol and the second, different protocol to enable a data connection to the device in a higher speed of two non-zero speeds of data transmittal. The adapter circuit may convert data between a single ended transmitter format of the analog front end circuit according to the first protocol and a differential pair transmitter format of the transceiver interface circuit according to the second, different protocol. The adapter circuit may convert data between a single ended receiver format of the analog front end circuit according to the first protocol and a differential pair receiver format of the transceiver interface circuit according to the second, different protocol. The apparatus may further include a repeater coupled between the analog front end circuit and the device. The adapter circuit may convert a port reset indication between the first protocol of the analog front end circuit and the second, different protocol of the transceiver interface circuit. The first protocol may be an embedded Universal Serial Bus (eUSB) specification and the second, different protocol may be a USB Transceiver Macrocell Interface (UTMI or UTMI+) specification. The device may include a second analog front end circuit coupled to the analog front end circuit, the second analog front end circuit may be coupled to a second adapter circuit of the device that is coupled to a second transceiver interface circuit of the device, and the second adapter circuit may convert between a first protocol of the second analog front end circuit and a second, different protocol of the second transceiver interface circuit. The adapter circuit may convert a power state indication between the first protocol and the second, different protocol. The adapter circuit may convert a suspend indication between the first protocol and the second, different protocol to suspend data transmittal of the device.

In another embodiment, an apparatus includes an analog front end circuit to couple to a device; a transceiver interface circuit to couple to a serial bus controller; and means coupled between the analog front end circuit and the transceiver interface circuit to convert between a first protocol of the analog front end circuit and a second, different protocol of the transceiver interface circuit.

In yet another embodiment, an apparatus comprises a data storage device that stores code that when executed by a hardware processor causes the hardware processor to perform any method disclosed herein. An apparatus may be as described in the detailed description. A method may be as described in the detailed description.

In another embodiment, a non-transitory machine readable medium that stores code that when executed by a machine causes the machine to perform a method comprising any method disclosed herein.

Circuitry (e.g., a hub, host, and/or device) may include a transmitter and/or a receiver to send and receive data, respectively, e.g., as part of a transceiver (e.g., a physical layer (PHY) circuit). Circuitry may connect via a (e.g., USB) cable, which may include a plug received by a receptacle.

One interconnect fabric architecture includes the Peripheral Component Interconnect (PCI) Express (PCIe) architecture. A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality of Service (QoS), Hot-Plug/Hot-Swap support, Data Integrity, and Error Handling are among some of the advanced features supported by PCI Express.

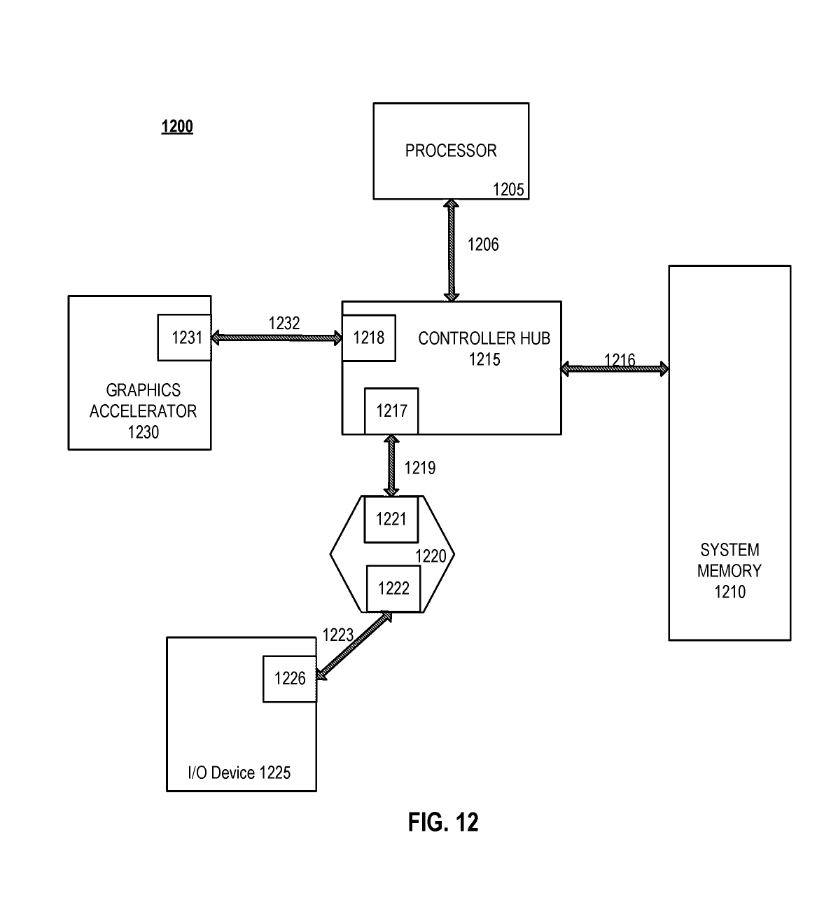

Referring to FIG. 12, an embodiment of a fabric composed of point-to-point Links that interconnect a set of components is illustrated. System 1200 includes processor 1205 and system memory 1210 coupled to controller hub 1215. Processor 1205 includes any processing element, such as a microprocessor, a host processor, an embedded processor, a co-processor, or other processor. Processor 1205 is coupled to controller hub 1215 through front-side bus (FSB) 1206. In one embodiment, FSB 1206 is a serial point-to-point interconnect as described below. In another embodiment, link 1206 includes a serial, differential interconnect architecture that is compliant with different interconnect standard.

System memory 1210 includes any memory device, such as random access memory (RAM), non-volatile (NV) memory, or other memory accessible by devices in system 1200. System memory 1210 is coupled to controller hub 1215 through memory interface 1216. Examples of a memory interface include a double-data rate (DDR) memory interface, a dual-channel DDR memory interface, and a dynamic RAM (DRAM) memory interface.

In one embodiment, controller hub 1215 is a root hub, root complex, or root controller in a Peripheral Component Interconnect Express (PCIe or PCIE) interconnection hierarchy. Examples of controller hub 1215 include a chipset, a memory controller hub (MCH), a northbridge, an interconnect controller hub (ICH) a southbridge, and a root controller/hub. Often the term chipset refers to two physically separate controller hubs, e.g., a memory controller hub (MCH) coupled to an interconnect controller hub (ICH). Note that current systems often include the MCH integrated with processor 1205, while controller 1215 is to communicate with I/O devices, in a similar manner as described below. In some embodiments, peer-to-peer routing is optionally supported through root complex 1215.

Here, controller hub 1215 is coupled to switch/bridge 1220 through serial link 1219. Input/output modules 1217 and 1221, which may also be referred to as interfaces/ports 1217 and 1221, include/implement a layered protocol stack to provide communication between controller hub 1215 and switch 1220. In one embodiment, multiple devices are capable of being coupled to switch 1220.

Switch/bridge 1220 routes packets/messages from device 1225 upstream, e.g., up a hierarchy towards a root complex, to controller hub 1215 and downstream, e.g., down a hierarchy away from a root controller, from processor 1205 or system memory 1210 to device 1225. Switch 1220, in one embodiment, is referred to as a logical assembly of multiple virtual PCI-to-PCI bridge devices. Device 1225 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 1225 may include a PCIe to PCI/PCI-X bridge to support legacy or other version PCI devices. Endpoint devices in PCIe are often classified as legacy, PCIe, or root complex integrated endpoints.

Graphics accelerator 1230 is also coupled to controller hub 1215 through serial link 1232. In one embodiment, graphics accelerator 1230 is coupled to an MCH, which is coupled to an ICH. Switch 1220, and accordingly to I/O device 1225 through serial link 1223, is then coupled to the ICH. I/O modules 1231 and 1218 are also to implement a layered protocol stack to communicate between graphics accelerator 1230 and controller hub 1215. Similar to the MCH discussion above, a graphics controller or the graphics accelerator 1230 itself may be integrated in processor 1205.

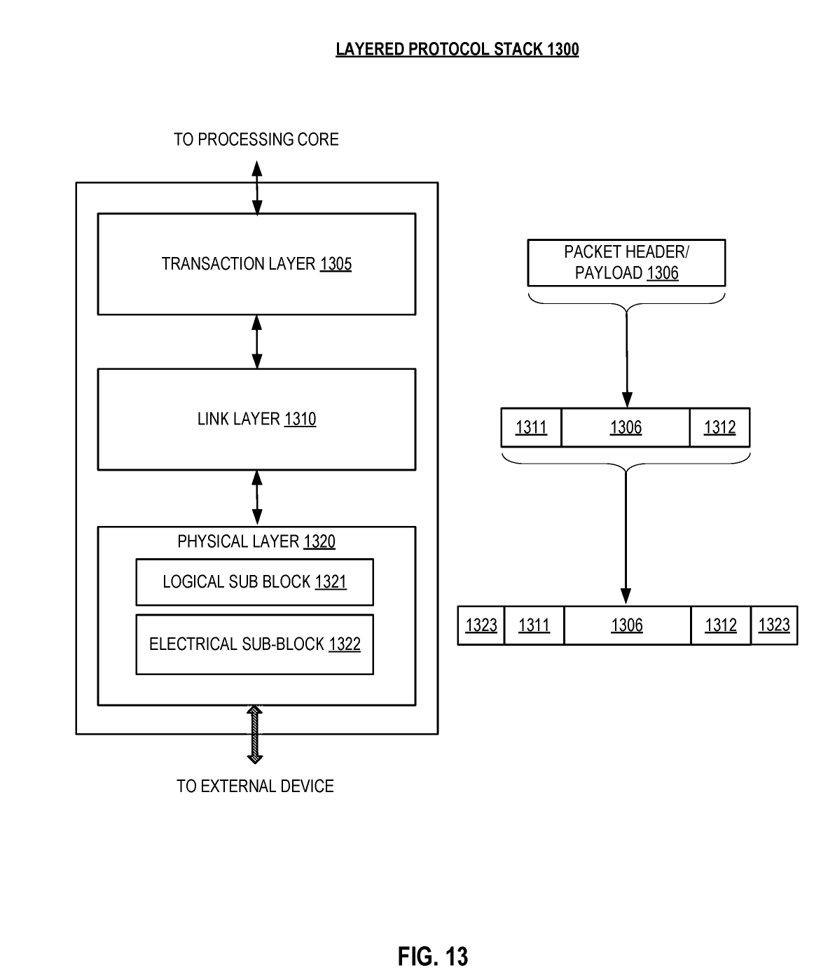

Turning to FIG. 13 an embodiment of a layered protocol stack is illustrated. Layered protocol stack 1300 includes any form of a layered communication stack, such as a Quick Path Interconnect (QPI) stack, a PCIe stack, a next generation high performance computing interconnect stack, or other layered stack. Although the discussion immediately below in reference to FIGS. 12-13 are in relation to a PCIe stack, the same concepts may be applied to other interconnect stacks. In one embodiment, protocol stack 1300 is a PCIe protocol stack including transaction layer 1305, link layer 1310, and physical layer 1320. An interface, such as interfaces 1217, 1218, 1221, 1222, 1226, and 1231 in FIG. 12, may be represented as communication protocol stack 1300. Representation as a communication protocol stack may also be referred to as a module or interface implementing/including a protocol stack.

PCI Express uses packets to communicate information between components. Packets are formed in the Transaction Layer 1305 and Data Link Layer 1310 to carry the information from the transmitting component to the receiving component. As the transmitted packets flow through the other layers, they are extended with additional information necessary to handle packets at those layers. At the receiving side the reverse process occurs and packets get transformed from their Physical Layer 1320 representation to the Data Link Layer 1310 representation and finally (for Transaction Layer Packets) to the form that can be processed by the Transaction Layer 1305 of the receiving device.

### Transaction Layer

In one embodiment, transaction layer 1305 is to provide an interface between a device's processing core and the interconnect architecture, such as data link layer 1310 and physical layer 1320. In this regard, a primary responsibility of the transaction layer 1305 is the assembly and disassembly of packets (e.g., transaction layer packets, or TLPs). The translation layer 1305 typically manages credit-base flow control for TLPs. PCIe implements split transactions, e.g., transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 1305. An external device at the opposite end of the link, such as a controller hub 1215 in FIG. 12, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message space transactions (or, simply messages) are defined to support in-band communication between PCIe agents.

Therefore, in one embodiment, transaction layer 1305 assembles packet header/payload 1306. Format for current packet headers/payloads may be found in the PCIe specification at the PCIe specification website.

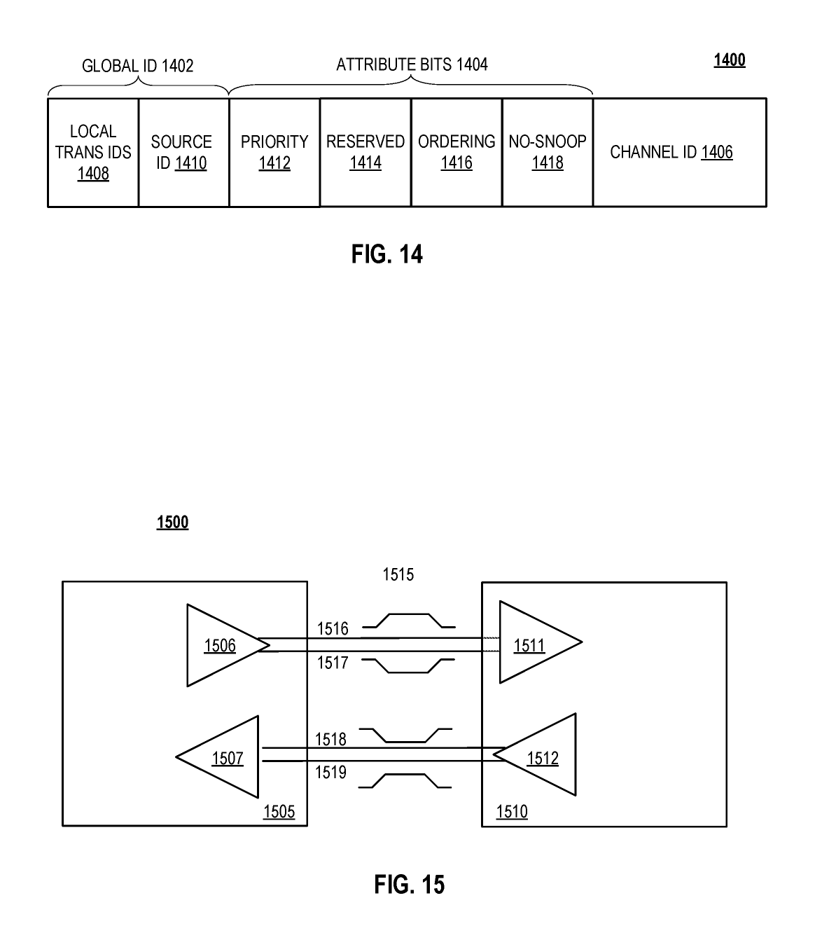

Referring to FIG. 14, an embodiment of a PCIe transaction descriptor is illustrated. In one embodiment, transaction descriptor 1400 is a mechanism for carrying transaction information. In this regard, transaction descriptor 1400 supports identification of transactions in a system. Other potential uses include tracking modifications of default transaction ordering and association of transaction with channels.

Transaction descriptor 1400 includes global identifier field 1402, attributes field 1404 and channel identifier field 1406. In the illustrated example, global identifier field 1402 is depicted comprising local transaction identifier field 1408 and source identifier field 1410. In one embodiment, global transaction identifier 1402 is unique for all outstanding requests.

According to one implementation, local transaction identifier field 1408 is a field generated by a requesting agent, and it is unique for all outstanding requests that require a completion for that requesting agent. Furthermore, in this example, source identifier 1410 uniquely identifies the requestor agent within a PCIe hierarchy. Accordingly, together with source ID 1410, local transaction identifier 1408 field provides global identification of a transaction within a hierarchy domain.

Attributes field 1404 specifies characteristics and relationships of the transaction. In this regard, attributes field 1404 is potentially used to provide additional information that allows modification of the default handling of transactions. In one embodiment, attributes field 1404 includes priority field 1412, reserved field 1414, ordering field 1416, and no-snoop field 1418. Here, priority sub-field 1412 may be modified by an initiator to assign a priority to the transaction. Reserved attribute field 1414 is left reserved for future, or vendor-defined usage. Possible usage models using priority or security attributes may be implemented using the reserved attribute field.

In this example, ordering attribute field 1416 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 1618 is utilized to determine if transactions are snooped. As shown, channel ID Field 1406 identifies a channel that a transaction is associated with.

### Link Layer

Link layer 1310, also referred to as data link layer 1310, acts as an intermediate stage between transaction layer 1305 and the physical layer 1320. In one embodiment, a responsibility of the data link layer 1310 is providing a reliable mechanism for exchanging Transaction Layer Packets (TLPs) between two components a link. One side of the Data Link Layer 1310 accepts TLPs assembled by the Transaction Layer 1305, applies packet sequence identifier 1311, e.g., an identification number or packet number, calculates and applies an error detection code, e.g., CRC 1312, and submits the modified TLPs to the Physical Layer 1320 for transmission across a physical to an external device.

### Physical Layer

In one embodiment, physical layer 1320 includes logical sub block 1321 and electrical sub-block 1322 to physically transmit a packet to an external device. Here, logical sub-block 1321 is responsible for the “digital” functions of Physical Layer 1321. In this regard, the logical sub-block includes a transmit section to prepare outgoing information for transmission by physical sub-block 1322, and a receiver section to identify and prepare received information before passing it to the Link Layer 1310.

Physical block 1322 includes a transmitter and a receiver. The transmitter is supplied by logical sub-block 1321 with symbols, which the transmitter serializes and transmits onto to an external device. The receiver is supplied with serialized symbols from an external device and transforms the received signals into a bit-stream. The bit-stream is de-serialized and supplied to logical sub-block 1321. In one embodiment, an 8b/10b transmission code is employed, where ten-bit symbols are transmitted/received. Here, special symbols are used to frame a packet with frames 1323. In addition, in one example, the receiver also provides a symbol clock recovered from the incoming serial stream.

As stated above, although transaction layer 1305, link layer 1310, and physical layer 1320 are discussed in reference to a specific embodiment of a PCIe protocol stack, a layered protocol stack is not so limited. In fact, any layered protocol may be included/implemented. As an example, a port/interface that is represented as a layered protocol includes: (1) a first layer to assemble packets, e.g., a transaction layer; a second layer to sequence packets, e.g., a link layer; and a third layer to transmit the packets, e.g., a physical layer. As a specific example, a common standard interface (CSI) layered protocol is utilized.

Referring next to FIG. 15, an embodiment of a PCIe serial point to point fabric 1500 is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 1506/1511 and a receive pair 1512/1507. Accordingly, device 1505 includes transmission logic 1506 to transmit data to device 1510 and receiving logic 1507 to receive data from device 1510. In other words, two transmitting paths, e.g., paths 1516 and 1517, and two receiving paths, e.g., paths 1518 and 1519, are included in a PCIe link.

A transmission path refers to any path for transmitting data, such as a transmission line, a copper line, an optical line, a wireless communication channel, an infrared communication link, or other communication path. A connection between two devices, such as device 1505 and device 1510, is referred to as a link, such as link 1515. A link may support one lane—each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider.

A differential pair refers to two transmission paths, such as lines 1516 and 1517, to transmit differential signals. As an example, when line 1516 toggles from a low voltage level to a high voltage level, e.g., a rising edge, line 1517 drives from a high logic level to a low logic level, e.g., a falling edge. Differential signals potentially demonstrate better electrical characteristics, such as better signal integrity, e.g., cross-coupling, voltage overshoot/undershoot, ringing, etc. This allows for better timing window, which enables faster transmission frequencies.

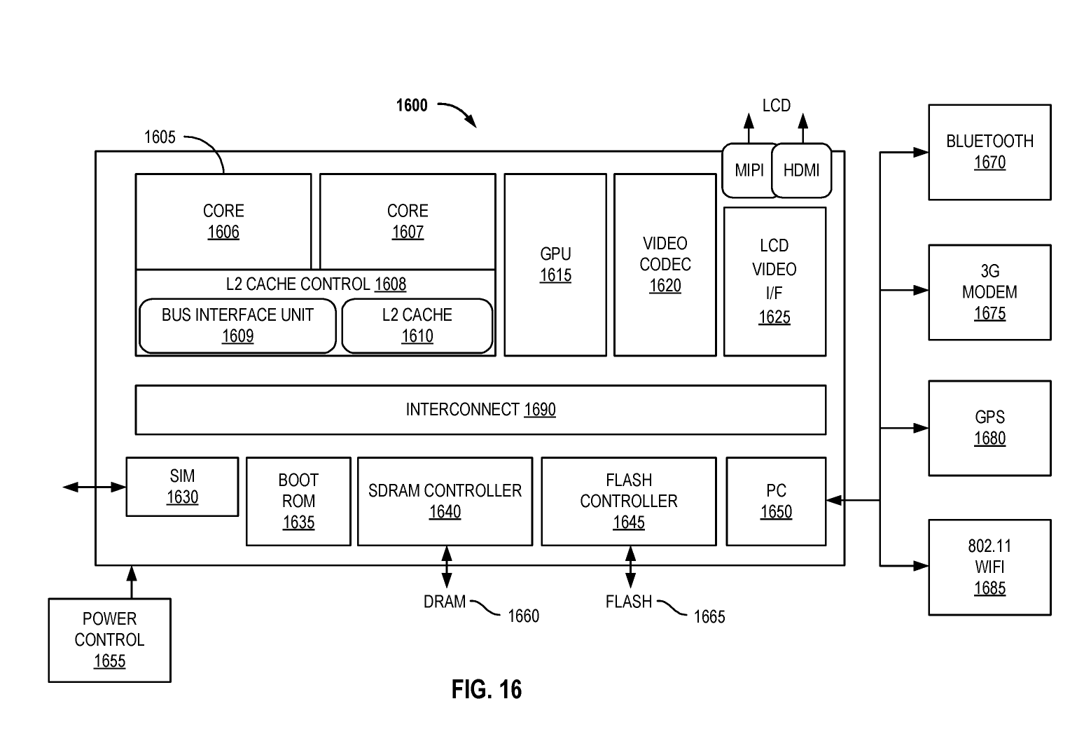

Turning next to FIG. 16, an embodiment of a system on-chip (SOC) design in accordance with the embodiments is depicted. As a specific illustrative example, SOC 1600 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1600 includes 2 cores-1606 and 1607. Similar to the discussion above, cores 1606 and 1607 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1606 and 1607 are coupled to cache control 1608 that is associated with bus interface unit 1609 and L2 cache 1610 to communicate with other parts of system 1600. Interconnect 1690 includes an on-chip interconnect, such as an IOSF, AMBA, or other interconnect discussed above, which potentially implements one or more aspects of the described embodiments.

Interconnect 1690 provides communication channels to the other components, such as a Subscriber Identity Module (SIM) 1630 to interface with a SIM card, a boot ROM 1635 to hold boot code for execution by cores 1606 and 1607 to initialize and boot SOC 1600, a SDRAM controller 1640 to interface with external memory (e.g. DRAM 1660), a flash controller 1645 to interface with non-volatile memory (e.g. Flash 1665), a peripheral control 1650 (e.g. Serial Peripheral Interface) to interface with peripherals, video codecs 1620 and Video interface 1625 to display and receive input (e.g. touch enabled input), GPU 1615 to perform graphics related computations, etc. Any of these interfaces may incorporate aspects of the embodiments described herein.

In addition, the system illustrates peripherals for communication, such as a Bluetooth module 1670, 3G modem 1675, GPS 1680, and WiFi 1685. Note as stated above, a UE includes a radio for communication. As a result, these peripheral communication modules are not all required. However, in a UE some form a radio for external communication is to be included.

Note that the apparatus, methods, and systems described above may be implemented in any electronic device or system as aforementioned. As specific illustrations, the figures below provide exemplary systems for utilizing the embodiments as described herein. As the systems below are described in more detail, a number of different interconnects are disclosed, described, and revisited from the discussion above. And as is readily apparent, the advances described above may be applied to any of those interconnects, fabrics, or architectures.

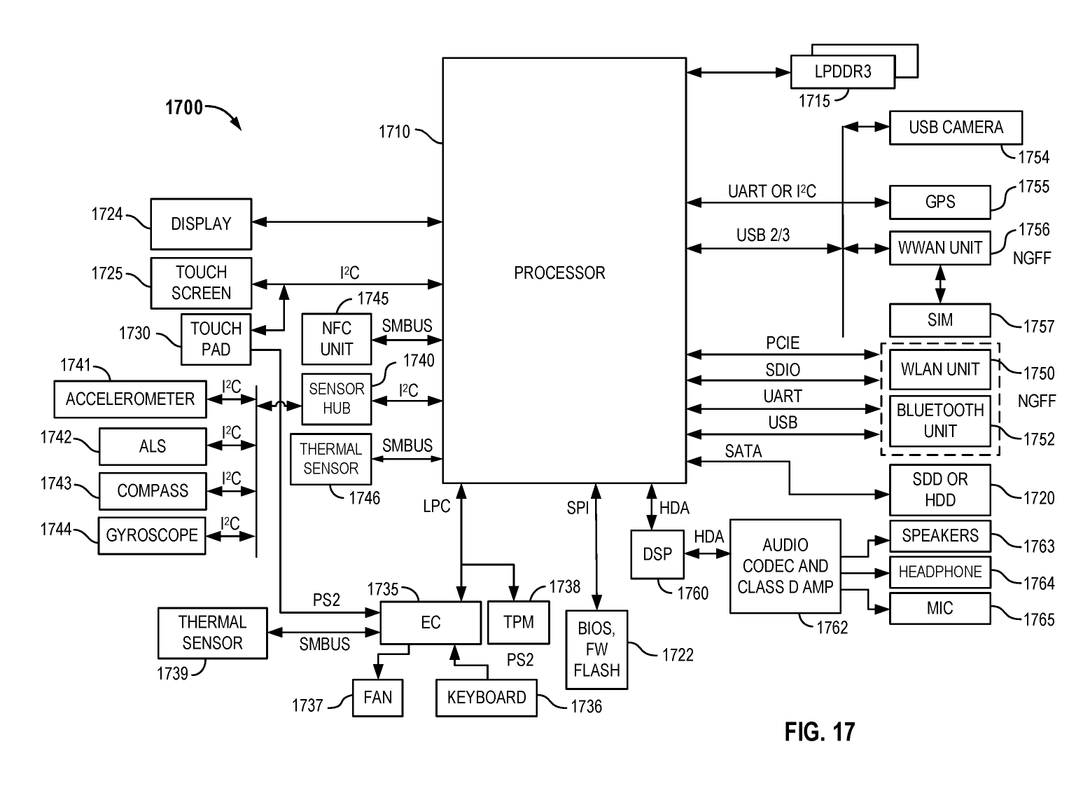

Referring now to FIG. 17, a block diagram of components present in a computer system in accordance with embodiments of the disclosure is illustrated. As shown in FIG. 17, system 1700 includes any combination of components. These components may be implemented as ICs, portions thereof, discrete electronic devices, or other modules, logic, hardware, software, firmware, or a combination thereof adapted in a computer system, or as components otherwise incorporated within a chassis of the computer system. Note also that the block diagram of FIG. 17 is intended to show a high level view of many components of the computer system. However, it is to be understood that some of the components shown may be omitted, additional components may be present, and different arrangement of the components shown may occur in other implementations. As a result, the embodiments described above may be implemented in any portion of one or more of the interconnects illustrated or described below.

As seen in FIG. 17, a processor 1710, in one embodiment, includes a microprocessor, multi-core processor, multithreaded processor, an ultra low voltage processor, an embedded processor, or other known processing element. In the illustrated implementation, processor 1710 acts as a main processing unit and central hub for communication with many of the various components of the system 1700. As one example, processor 1710 is implemented as a system on a chip (SoC). As a specific illustrative example, processor 1710 includes an Intel® Architecture Core™-based processor such as an i3, i5, i7 or another such processor available from Intel Corporation, Santa Clara, Calif.

However, understand that other low power processors such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note that many of the customer versions of such processors are modified and varied; however, they may support or recognize a specific instructions set that performs defined algorithms as set forth by the processor licensor. Here, the microarchitectural implementation may vary, but the architectural function of the processor is usually consistent. Certain details regarding the architecture and operation of processor 1710 in one implementation will be discussed further below to provide an illustrative example.

Processor 1710, in one embodiment, communicates with a system memory 1715. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP) or quad die package (Q17P). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage 1720 may also couple to processor 1710. In various embodiments, to enable a thinner and lighter system design as well as to improve system responsiveness, this mass storage may be implemented via a SSD. However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also shown in FIG. 17, a flash device 1722 may be coupled to processor 1710, e.g., via a serial peripheral interface (SPI). This flash device may provide for non-volatile storage of system software, including a basic input/output software (BIOS) as well as other firmware of the system.

In various embodiments, mass storage of the system is implemented by a SSD alone or as a disk, optical or other drive with an SSD cache. In some embodiments, the mass storage is implemented as a SSD or as a HDD along with a restore (RST) cache module. In various implementations, the HDD provides for storage of between 320 GB-4 terabytes (TB) and upward while the RST cache is implemented with a SSD having a capacity of 24 GB-256 GB. Note that such SSD cache may be configured as a single level cache (SLC) or multi-level cache (MLC) option to provide an appropriate level of responsiveness. In a SSD-only option, the module may be accommodated in various locations such as in a mSATA or NGFF slot. As an example, an SSD has a capacity ranging from 120 GB-1 TB.

Various input/output (10) devices may be present within system 1700. Specifically shown in the embodiment of FIG. 17 is a display 1724 which may be a high definition LCD or LED panel configured within a lid portion of the chassis. This display panel may also provide for a touch screen 1725, e.g., adapted externally over the display panel such that via a user's interaction with this touch screen, user inputs can be provided to the system to enable desired operations, e.g., with regard to the display of information, accessing of information and so forth. In one embodiment, display 1724 may be coupled to processor 1710 via a display interconnect that can be implemented as a high performance graphics interconnect. Touch screen 1725 may be coupled to processor 1710 via another interconnect, which in an embodiment can be an I²C interconnect. As further shown in FIG. 17, in addition to touch screen 1725, user input by way of touch can also occur via a touch pad 1730 which may be configured within the chassis and may also be coupled to the same I²C interconnect as touch screen 1725.

The display panel may operate in multiple modes. In a first mode, the display panel can be arranged in a transparent state in which the display panel is transparent to visible light. In various embodiments, the majority of the display panel may be a display except for a bezel around the periphery. When the system is operated in a notebook mode and the display panel is operated in a transparent state, a user may view information that is presented on the display panel while also being able to view objects behind the display. In addition, information displayed on the display panel may be viewed by a user positioned behind the display. Or the operating state of the display panel can be an opaque state in which visible light does not transmit through the display panel.

In a tablet mode the system is folded shut such that the back display surface of the display panel comes to rest in a position such that it faces outwardly towards a user, when the bottom surface of the base panel is rested on a surface or held by the user. In the tablet mode of operation, the back display surface performs the role of a display and user interface, as this surface may have touch screen functionality and may perform other known functions of a conventional touch screen device, such as a tablet device. To this end, the display panel may include a transparency-adjusting layer that is disposed between a touch screen layer and a front display surface. In some embodiments the transparency-adjusting layer may be an electrochromic layer (EC), a LCD layer, or a combination of EC and LCD layers.

In various embodiments, the display can be of different sizes, e.g., an 11.6″ or a 13.3″ screen, and may have a 16:9 aspect ratio, and at least 300 nits brightness. Also the display may be of full high definition (HD) resolution (at least 1920×1080 p), be compatible with an embedded display port (eDP), and be a low power panel with panel self-refresh.

As to touch screen capabilities, the system may provide for a display multi-touch panel that is multi-touch capacitive and being at least 5 finger capable. And in some embodiments, the display may be 10 finger capable. In one embodiment, the touch screen is accommodated within a damage and scratch-resistant glass and coating (e.g., Gorilla Glass™ or Gorilla Glass 2™) for low friction to reduce “finger burn” and avoid “finger skipping”. To provide for an enhanced touch experience and responsiveness, the touch panel, in some implementations, has multi-touch functionality, such as less than 2 frames (30 Hz) per static view during pinch zoom, and single-touch functionality of less than 1 cm per frame (30 Hz) with 200 ms (lag on finger to pointer). The display, in some implementations, supports edge-to-edge glass with a minimal screen bezel that is also flush with the panel surface, and limited 10 interference when using multi-touch.

For perceptual computing and other purposes, various sensors may be present within the system and may be coupled to processor 1710 in different manners. Certain inertial and environmental sensors may couple to processor 1710 through a sensor hub 1740, e.g., via an I²C interconnect. In the embodiment shown in FIG. 17, these sensors may include an accelerometer 1741, an ambient light sensor (ALS) 1742, a compass 1743 and a gyroscope 1744. Other environmental sensors may include one or more thermal sensors 1746 which in some embodiments couple to processor 1710 via a system management bus (SMBus) bus.

Using the various inertial and environmental sensors present in a platform, many different use cases may be realized. These use cases enable advanced computing operations including perceptual computing and also allow for enhancements with regard to power management/battery life, security, and system responsiveness.

For example with regard to power management/battery life issues, based at least on part on information from an ambient light sensor, the ambient light conditions in a location of the platform are determined and intensity of the display controlled accordingly. Thus, power consumed in operating the display is reduced in certain light conditions.

As to security operations, based on context information obtained from the sensors such as location information, it may be determined whether a user is allowed to access certain secure documents. For example, a user may be permitted to access such documents at a work place or a home location. However, the user is prevented from accessing such documents when the platform is present at a public location. This determination, in one embodiment, is based on location information, e.g., determined via a GPS sensor or camera recognition of landmarks. Other security operations may include providing for pairing of devices within a close range of each other, e.g., a portable platform as described herein and a user's desktop computer, mobile telephone or so forth. Certain sharing, in some implementations, are realized via near field communication when these devices are so paired. However, when the devices exceed a certain range, such sharing may be disabled. Furthermore, when pairing a platform as described herein and a smartphone, an alarm may be configured to be triggered when the devices move more than a predetermined distance from each other, when in a public location. In contrast, when these paired devices are in a safe location, e.g., a work place or home location, the devices may exceed this predetermined limit without triggering such alarm.

Responsiveness may also be enhanced using the sensor information. For example, even when a platform is in a low power state, the sensors may still be enabled to run at a relatively low frequency. Accordingly, any changes in a location of the platform, e.g., as determined by inertial sensors, GPS sensor, or so forth is determined. If no such changes have been registered, a faster connection to a previous wireless hub such as a Wi-Fi™ access point or similar wireless enabler occurs, as there is no need to scan for available wireless network resources in this case. Thus, a greater level of responsiveness when waking from a low power state is achieved.

It is to be understood that many other use cases may be enabled using sensor information obtained via the integrated sensors within a platform as described herein, and the above examples are only for purposes of illustration. Using a system as described herein, a perceptual computing system may allow for the addition of alternative input modalities, including gesture recognition, and enable the system to sense user operations and intent.

In some embodiments one or more infrared or other heat sensing elements, or any other element for sensing the presence or movement of a user may be present. Such sensing elements may include multiple different elements working together, working in sequence, or both. For example, sensing elements include elements that provide initial sensing, such as light or sound projection, followed by sensing for gesture detection by, for example, an ultrasonic time of flight camera or a patterned light camera.

Also in some embodiments, the system includes a light generator to produce an illuminated line. In some embodiments, this line provides a visual cue regarding a virtual boundary, namely an imaginary or virtual location in space, where action of the user to pass or break through the virtual boundary or plane is interpreted as an intent to engage with the computing system. In some embodiments, the illuminated line may change colors as the computing system transitions into different states with regard to the user. The illuminated line may be used to provide a visual cue for the user of a virtual boundary in space, and may be used by the system to determine transitions in state of the computer with regard to the user, including determining when the user wishes to engage with the computer.

In some embodiments, the computer senses user position and operates to interpret the movement of a hand of the user through the virtual boundary as a gesture indicating an intention of the user to engage with the computer. In some embodiments, upon the user passing through the virtual line or plane the light generated by the light generator may change, thereby providing visual feedback to the user that the user has entered an area for providing gestures to provide input to the computer.

Display screens may provide visual indications of transitions of state of the computing system with regard to a user. In some embodiments, a first screen is provided in a first state in which the presence of a user is sensed by the system, such as through use of one or more of the sensing elements.

In some implementations, the system acts to sense user identity, such as by facial recognition. Here, transition to a second screen may be provided in a second state, in which the computing system has recognized the user identity, where this second the screen provides visual feedback to the user that the user has transitioned into a new state. Transition to a third screen may occur in a third state in which the user has confirmed recognition of the user.

In some embodiments, the computing system may use a transition mechanism to determine a location of a virtual boundary for a user, where the location of the virtual boundary may vary with user and context. The computing system may generate a light, such as an illuminated line, to indicate the virtual boundary for engaging with the system. In some embodiments, the computing system may be in a waiting state, and the light may be produced in a first color. The computing system may detect whether the user has reached past the virtual boundary, such as by sensing the presence and movement of the user using sensing elements.

In some embodiments, if the user has been detected as having crossed the virtual boundary (such as the hands of the user being closer to the computing system than the virtual boundary line), the computing system may transition to a state for receiving gesture inputs from the user, where a mechanism to indicate the transition may include the light indicating the virtual boundary changing to a second color.

In some embodiments, the computing system may then determine whether gesture movement is detected. If gesture movement is detected, the computing system may proceed with a gesture recognition process, which may include the use of data from a gesture data library, which may reside in memory in the computing device or may be otherwise accessed by the computing device.

If a gesture of the user is recognized, the computing system may perform a function in response to the input, and return to receive additional gestures if the user is within the virtual boundary. In some embodiments, if the gesture is not recognized, the computing system may transition into an error state, where a mechanism to indicate the error state may include the light indicating the virtual boundary changing to a third color, with the system returning to receive additional gestures if the user is within the virtual boundary for engaging with the computing system.

As mentioned above, in other embodiments the system can be configured as a convertible tablet system that can be used in at least two different modes, a tablet mode and a notebook mode. The convertible system may have two panels, namely a display panel and a base panel such that in the tablet mode the two panels are disposed in a stack on top of one another. In the tablet mode, the display panel faces outwardly and may provide touch screen functionality as found in conventional tablets. In the notebook mode, the two panels may be arranged in an open clamshell configuration.

In various embodiments, the accelerometer may be a 3-axis accelerometer having data rates of at least 50 Hz. A gyroscope may also be included, which can be a 3-axis gyroscope. In addition, an e-compass/magnetometer may be present. Also, one or more proximity sensors may be provided (e.g., for lid open to sense when a person is in proximity (or not) to the system and adjust power/performance to extend battery life). For some OS's Sensor Fusion capability including the accelerometer, gyroscope, and compass may provide enhanced features. In addition, via a sensor hub having a real-time clock (RTC), a wake from sensors mechanism may be realized to receive sensor input when a remainder of the system is in a low power state.

In some embodiments, an internal lid/display open switch or sensor to indicate when the lid is closed/open, and can be used to place the system into Connected Standby or automatically wake from Connected Standby state. Other system sensors can include ACPI sensors for internal processor, memory, and skin temperature monitoring to enable changes to processor and system operating states based on sensed parameters.

In an embodiment, the OS may be a Microsoft® Windows® 8 OS that implements Connected Standby (also referred to herein as Win8 CS). Windows 8 Connected Standby or another OS having a similar state can provide, via a platform as described herein, very low ultra idle power to enable applications to remain connected, e.g., to a cloud-based location, at very low power consumption. The platform can supports 3 power states, namely screen on (normal); Connected Standby (as a default “off” state); and shutdown (zero watts of power consumption). Thus in the Connected Standby state, the platform is logically on (at minimal power levels) even though the screen is off. In such a platform, power management can be made to be transparent to applications and maintain constant connectivity, in part due to offload technology to enable the lowest powered component to perform an operation.

Also seen in FIG. 17, various peripheral devices may couple to processor 1710 via a low pin count (LPC) interconnect. In the embodiment shown, various components can be coupled through an embedded controller (EC) 1735. Such components can include a keyboard 1736 (e.g., coupled via a PS2 interface), a fan 1737, and a thermal sensor 1739. In some embodiments, touch pad 1730 may also couple to EC 1735 via a PS2 interface. In addition, a security processor such as a trusted platform module (TPM) 1738 in accordance with the Trusted Computing Group (TCG) TPM Specification Version 1.2, dated Oct. 2, 2003, may also couple to processor 1710 via this LPC interconnect. However, understand the scope of the present disclosure is not limited in this regard and secure processing and storage of secure information may be in another protected location such as a static random access memory (SRAM) in a security coprocessor, or as encrypted data blobs that are only decrypted when protected by a secure enclave (SE) processor mode.

In a particular implementation, peripheral ports may include a high definition media interface (HDMI) connector (which can be of different form factors such as full size, mini or micro); one or more USB ports, such as full-size external ports in accordance with a Universal Serial Bus specification, with at least one powered for charging of USB devices (such as smartphones) when the system is in Connected Standby state and is plugged into AC wall power. In addition, one or more Thunderbolt™ ports can be provided. Other ports may include an externally accessible card reader such as a full size SD-XC card reader and/or a SIM card reader for WWAN (e.g., an 8 pin card reader). For audio, a 3.5 mm jack with stereo sound and microphone capability (e.g., combination functionality) can be present, with support for jack detection (e.g., headphone only support using microphone in the lid or headphone with microphone in cable). In some embodiments, this jack can be re-taskable between stereo headphone and stereo microphone input. Also, a power jack can be provided for coupling to an AC brick.

System 1700 can communicate with external devices in a variety of manners, including wirelessly. In the embodiment shown in FIG. 17, various wireless modules, each of which can correspond to a radio configured for a particular wireless communication protocol, are present. One manner for wireless communication in a short range such as a near field may be via a near field communication (NFC) unit 1745 which may communicate, in one embodiment with processor 1710 via an SMBus. Note that via this NFC unit 1745, devices in close proximity to each other can communicate. For example, a user can enable system 1700 to communicate with another (e.g.,) portable device such as a smartphone of the user via adapting the two devices together in close relation and enabling transfer of information such as identification information payment information, data such as image data or so forth. Wireless power transfer may also be performed using a NFC system.

Using the NFC unit described herein, users can bump devices side-to-side and place devices side-by-side for near field coupling functions (such as near field communication and wireless power transfer (WPT)) by leveraging the coupling between coils of one or more of such devices. More specifically, embodiments provide devices with strategically shaped, and placed, ferrite materials, to provide for better coupling of the coils. Each coil has an inductance associated with it, which can be chosen in conjunction with the resistive, capacitive, and other features of the system to enable a common resonant frequency for the system.

As further seen in FIG. 17, additional wireless units can include other short range wireless engines including a WLAN unit 1750 and a Bluetooth unit 1752. Using WLAN unit 1750, Wi-Fi™ communications in accordance with a given Institute of Electrical and Electronics Engineers (IEEE) 802.11 standard can be realized, while via Bluetooth unit 1752, short range communications via a Bluetooth protocol can occur. These units may communicate with processor 1710 via, e.g., a USB link or a universal asynchronous receiver transmitter (UART) link. Or these units may couple to processor 1710 via an interconnect according to a Peripheral Component Interconnect Express™ (PCIe™) protocol, e.g., in accordance with the PCI Express™ Specification Base Specification version 3.0 (published Jan. 17, 2007), or another such protocol such as a serial data input/output (SDIO) standard. Of course, the actual physical connection between these peripheral devices, which may be configured on one or more add-in cards, can be by way of the NGFF connectors adapted to a motherboard.

In addition, wireless wide area communications, e.g., according to a cellular or other wireless wide area protocol, can occur via a WWAN unit 1756 which in turn may couple to a subscriber identity module (SIM) 1757. In addition, to enable receipt and use of location information, a GPS module 1755 may also be present. Note that in the embodiment shown in FIG. 17, WWAN unit 1756 and an integrated capture device such as a camera module 1754 may communicate via a given USB protocol, e.g., USB 2.0 or 3.0 link, or a UART or I²C protocol. Again the actual physical connection of these units can be via adaptation of a NGFF add-in card to an NGFF connector configured on the motherboard.

In a particular embodiment, wireless functionality can be provided modularly, e.g., with a WiFi™ 802.11ac solution (e.g., add-in card that is backward compatible with IEEE 802.11abgn) with support for Windows 8 CS. This card can be configured in an internal slot (e.g., via an NGFF adapter). An additional module may provide for Bluetooth capability (e.g., Bluetooth 4.0 with backwards compatibility) as well as Intel® Wireless Display functionality. In addition NFC support may be provided via a separate device or multi-function device, and can be positioned as an example, in a front right portion of the chassis for easy access. A still additional module may be a WWAN device that can provide support for 3G/4G/LTE and GPS. This module can be implemented in an internal (e.g., NGFF) slot. Integrated antenna support can be provided for WiFi™, Bluetooth, WWAN, NFC and GPS, enabling seamless transition from WiFi™ to WWAN radios, wireless gigabit (WiGig) in accordance with the Wireless Gigabit Specification (July 2010), and vice versa.

As described above, an integrated camera can be incorporated in the lid. As one example, this camera can be a high resolution camera, e.g., having a resolution of at least 2.0 megapixels (MP) and extending to 6.0 MP and beyond.

To provide for audio inputs and outputs, an audio processor can be implemented via a digital signal processor (DSP) 1760, which may couple to processor 1710 via a high definition audio (HDA) link. Similarly, DSP 1760 may communicate with an integrated coder/decoder (CODEC) and amplifier 1762 that in turn may couple to output speakers 1763 which may be implemented within the chassis. Similarly, amplifier and CODEC 1762 can be coupled to receive audio inputs from a microphone 1765 which in an embodiment can be implemented via dual array microphones (such as a digital microphone array) to provide for high quality audio inputs to enable voice-activated control of various operations within the system. Note also that audio outputs can be provided from amplifier/CODEC 1762 to a headphone jack 1764. Although shown with these particular components in the embodiment of FIG. 17, understand the scope of the present disclosure is not limited in this regard.

In a particular embodiment, the digital audio codec and amplifier are capable of driving the stereo headphone jack, stereo microphone jack, an internal microphone array and stereo speakers. In different implementations, the codec can be integrated into an audio DSP or coupled via an HD audio path to a peripheral controller hub (PCH). In some implementations, in addition to integrated stereo speakers, one or more bass speakers can be provided, and the speaker solution can support DTS audio.

In some embodiments, processor 1710 may be powered by an external voltage regulator (VR) and multiple internal voltage regulators that are integrated inside the processor die, referred to as fully integrated voltage regulators (FIVRs). The use of multiple FIVRs in the processor enables the grouping of components into separate power planes, such that power is regulated and supplied by the FIVR to only those components in the group. During power management, a given power plane of one FIVR may be powered down or off when the processor is placed into a certain low power state, while another power plane of another FIVR remains active, or fully powered.

In one embodiment, a sustain power plane can be used during some deep sleep states to power on the I/O pins for several I/O signals, such as the interface between the processor and a PCH, the interface with the external VR and the interface with EC 1735. This sustain power plane also powers an on-die voltage regulator that supports the on-board SRAM or other cache memory in which the processor context is stored during the sleep state. The sustain power plane is also used to power on the processor's wakeup logic that monitors and processes the various wakeup source signals.

During power management, while other power planes are powered down or off when the processor enters certain deep sleep states, the sustain power plane remains powered on to support the above-referenced components. However, this can lead to unnecessary power consumption or dissipation when those components are not needed. To this end, embodiments may provide a connected standby sleep state to maintain processor context using a dedicated power plane. In one embodiment, the connected standby sleep state facilitates processor wakeup using resources of a PCH which itself may be present in a package with the processor. In one embodiment, the connected standby sleep state facilitates sustaining processor architectural functions in the PCH until processor wakeup, this enabling turning off all of the unnecessary processor components that were previously left powered on during deep sleep states, including turning off all of the clocks. In one embodiment, the PCH contains a time stamp counter (TSC) and connected standby logic for controlling the system during the connected standby state. The integrated voltage regulator for the sustain power plane may reside on the PCH as well.

In an embodiment, during the connected standby state, an integrated voltage regulator may function as a dedicated power plane that remains powered on to support the dedicated cache memory in which the processor context is stored such as critical state variables when the processor enters the deep sleep states and connected standby state. This critical state may include state variables associated with the architectural, micro-architectural, debug state, and/or similar state variables associated with the processor.

The wakeup source signals from EC 1235 may be sent to the PCH instead of the processor during the connected standby state so that the PCH can manage the wakeup processing instead of the processor. In addition, the TSC is maintained in the PCH to facilitate sustaining processor architectural functions. Although shown with these particular components in the embodiment of FIG. 12, understand the scope of the present disclosure is not limited in this regard.

Power control in the processor can lead to enhanced power savings. For example, power can be dynamically allocate between cores, individual cores can change frequency/voltage, and multiple deep low power states can be provided to enable very low power consumption. In addition, dynamic control of the cores or independent core portions can provide for reduced power consumption by powering off components when they are not being used.

Some implementations may provide a specific power management IC (PMIC) to control platform power. Using this solution, a system may see very low (e.g., less than 5%) battery degradation over an extended duration (e.g., 16 hours) when in a given standby state, such as when in a Win8 Connected Standby state. In a Win8 idle state a battery life exceeding, e.g., 9 hours may be realized (e.g., at 150 nits). As to video playback, a long battery life can be realized, e.g., full HD video playback can occur for a minimum of 6 hours. A platform in one implementation may have an energy capacity of, e.g., 35 watt hours (Whr) for a Win8 CS using an SSD and (e.g.,) 40-44 Whr for Win8 CS using an HDD with a RST cache configuration.

A particular implementation may provide support for 15 W nominal CPU thermal design power (TDP), with a configurable CPU TDP of up to approximately 25 W TDP design point. The platform may include minimal vents owing to the thermal features described above. In addition, the platform is pillow-friendly (in that no hot air is blowing at the user). Different maximum temperature points can be realized depending on the chassis material. In one implementation of a plastic chassis (at least having to lid or base portion of plastic), the maximum operating temperature can be 52 degrees Celsius (C). And for an implementation of a metal chassis, the maximum operating temperature can be 46° C.

In different implementations, a security module such as a TPM can be integrated into a processor or can be a discrete device such as a TPM 2.0 device. With an integrated security module, also referred to as Platform Trust Technology (PTT), BIOS/firmware can be enabled to expose certain hardware features for certain security features, including secure instructions, secure boot, Intel® Anti-Theft Technology, Intel® Identity Protection Technology, Intel® Trusted Execution Technology (TXT), and Intel® Manageability Engine Technology along with secure user interfaces such as a secure keyboard and display.

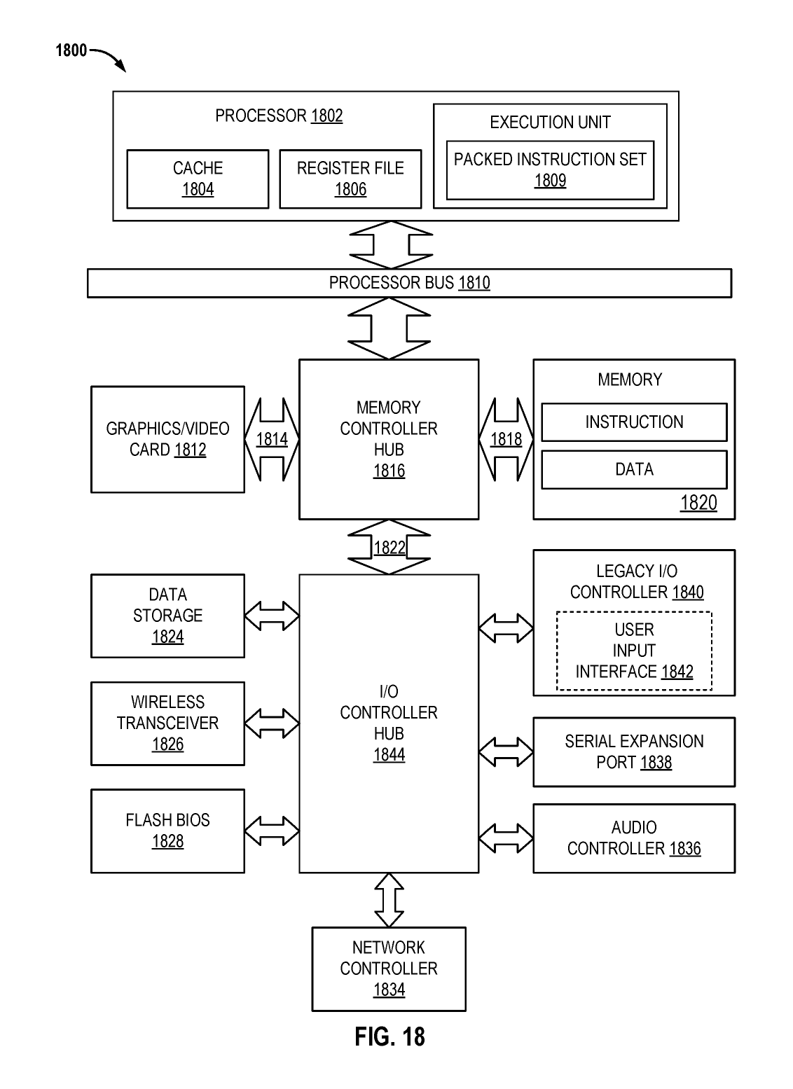

Turning to FIG. 18, a block diagram of an exemplary computer system formed with a processor that includes execution units to execute an instruction, where one or more of the interconnects implement one or more features in accordance with embodiments of the disclosure is illustrated. System 1800 includes a component, such as a processor 1802 to employ execution units including logic to perform algorithms for process data, in accordance with the present disclosure, such as in the embodiment described herein. System 1800 is representative of processing systems based on the PENTIUM III™, PENTIUM 4™, Xeon™ Itanium, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 1800 executes a version of the WINDOWS™ operating system available from Microsoft Corporation of Redmond, Wash., although other operating systems (UNIX and Linux for example), embedded software, and/or graphical user interfaces, may also be used. Thus, embodiments of the present disclosure are not limited to any specific combination of hardware circuitry and software.

Embodiments are not limited to computer systems. Alternative embodiments of the present disclosure can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 1802 includes one or more execution units 1808 to implement an algorithm that is to perform at least one instruction. One embodiment may be described in the context of a single processor desktop or server system, but alternative embodiments may be included in a multiprocessor system. System 1800 is an example of a ‘hub’ system architecture. The computer system 1800 includes a processor 1802 to process data signals. The processor 1802, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 1802 is coupled to a processor bus 1810 that transmits data signals between the processor 1802 and other components in the system 1800. The elements of system 1800 (e.g. graphics accelerator 1812, memory controller hub 2016, memory 1820, I/O controller hub 1844, wireless transceiver 1826, Flash BIOS 1828, Network controller 1834, Audio controller 1836, Serial expansion port 1838, I/O controller 1840, etc.) perform their conventional functions that are well known to those familiar with the art.

In one embodiment, the processor 1802 includes a Level 1 (L1) internal cache memory 1804. Depending on the architecture, the processor 1802 may have a single internal cache or multiple levels of internal caches. Other embodiments include a combination of both internal and external caches depending on the particular implementation and needs. Register file 1806 is to store different types of data in various registers including integer registers, floating point registers, vector registers, banked registers, shadow registers, checkpoint registers, status registers, and instruction pointer register.

Execution unit 1808, including logic to perform integer and floating point operations, also resides in the processor 1802. The processor 1802, in one embodiment, includes a microcode (μcode) ROM to store microcode, which when executed, is to perform algorithms for certain macroinstructions or handle complex scenarios. Here, microcode is potentially updateable to handle logic bugs/fixes for processor 1802. For one embodiment, execution unit 1808 includes logic to handle a packed instruction set 1809. By including the packed instruction set 1809 in the instruction set of a general-purpose processor 1802, along with associated circuitry to execute the instructions, the operations used by many multimedia applications may be performed using packed data in a general-purpose processor 1802. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 1808 may also be used in micro controllers, embedded processors, graphics devices, DSPs, and other types of logic circuits. System 1800 includes a memory 1820. Memory 1820 includes a dynamic random access memory (DRAM) device, a static random access memory (SRAM) device, flash memory device, or other memory device. Memory 1820 stores instructions and/or data represented by data signals that are to be executed by the processor 1802.

Note that any of the aforementioned features or aspects of the embodiments of the disclosure may be utilized on one or more interconnect illustrated in FIG. 18. For example, an on-die interconnect (ODI), which is not shown, for coupling internal units of processor 1802 implements one or more aspects of the disclosure herein. Or the embodiments of the disclosure are associated with a processor bus 1810 (e.g. Intel Quick Path Interconnect (QPI) or other known high performance computing interconnect), a high bandwidth memory path 1818 to memory 1820, a point-to-point link 1814 to graphics accelerator 1812 (e.g. a Peripheral Component Interconnect express (PCIe) compliant fabric), a controller hub interconnect 1822, an I/O or other interconnect (e.g. USB, PCI, PCIe) for coupling the other illustrated components. Some examples of such components include the audio controller 1836, firmware hub (flash BIOS) 1828, wireless transceiver 1826, data storage 1824, legacy I/O controller 1810 containing user input and keyboard interfaces 1842, a serial expansion port 1838 such as Universal Serial Bus (USB), and a network controller 1834. The data storage device 1824 can comprise a hard disk drive, a floppy disk drive, a CD-ROM device, a flash memory device, or other mass storage device.

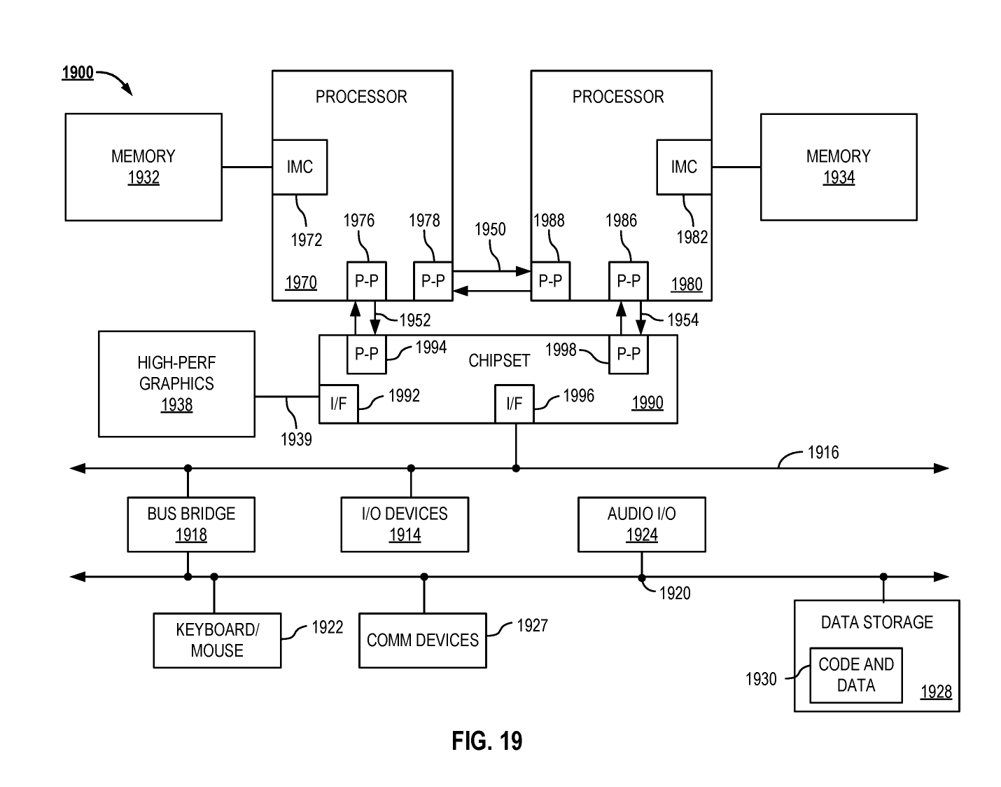

Referring now to FIG. 19, shown is a block diagram of a second system 1900 in accordance with an embodiment of the present disclosure. As shown in FIG. 19, multiprocessor system 1900 is a point-to-point interconnect system, and includes a first processor 1970 and a second processor 1980 coupled via a point-to-point interconnect 1950. Each of processors 1970 and 1980 may be some version of a processor. In one embodiment, 1952 and 1954 are part of a serial, point-to-point coherent interconnect fabric, such as Intel's Quick Path Interconnect (QPI) architecture. As a result, embodiments of the disclosure may be implemented within the QPI architecture.

While shown with only two processors 1970, 1980, it is to be understood that the scope of the present disclosure is not so limited. In other embodiments, one or more additional processors may be present in a given processor.

Processors 1970 and 1980 are shown including integrated memory controller units 1972 and 1982, respectively. Processor 1970 also includes as part of its bus controller units point-to-point (P-P) interfaces 1976 and 1978; similarly, second processor 1980 includes P-P interfaces 1986 and 1988. Processors 1970, 1980 may exchange information via a point-to-point (P-P) interface 1950 using P-P interface circuits 1978, 1988. As shown in FIG. 19, IMCs 1972 and 1982 couple the processors to respective memories, namely a memory 1932 and a memory 1934, which may be portions of main memory locally attached to the respective processors.

Processors 1970, 1980 each exchange information with a chipset 1990 via individual P-P interfaces 1952, 1954 using point to point interface circuits 1976, 1994, 1986, 1998. Chipset 1990 also exchanges information with a high-performance graphics circuit 1938 via an interface circuit 1992 along a high-performance graphics interconnect 1939.

A shared cache (not shown) may be included in either processor or outside of both processors; yet connected with the processors via P-P interconnect, such that either or both processors' local cache information may be stored in the shared cache if a processor is placed into a low power mode.

Chipset 1990 may be coupled to a first bus 1916 via an interface 1996. In one embodiment, first bus 1916 may be a Peripheral Component Interconnect (PCI) bus, or a bus such as a PCI Express bus or another third generation 110 interconnect bus, although the scope of the present disclosure is not so limited.

As shown in FIG. 19, various 110 devices 1914 are coupled to first bus 1916, along with a bus bridge 1918 which couples first bus 1916 to a second bus 1920. In one embodiment, second bus 1920 includes a low pin count (LPC) bus. Various devices are coupled to second bus 1920 including, for example, a keyboard and/or mouse 1922, communication devices 1927 and a storage unit 1928 such as a disk drive or other mass storage device which often includes instructions/code and data 1930, in one embodiment. Further, an audio I/O 1924 is shown coupled to second bus 1920. Note that other architectures are possible, where the included components and interconnect architectures vary. For example, instead of the point-to-point architecture of FIG. 19, a system may implement a multi-drop bus or other such architecture.

Embodiments (e.g., of the mechanisms) disclosed herein may be implemented in hardware (e.g., a computer programmed to perform a method may be as described in the detailed description), software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code may be executed to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. The mechanisms described herein are not limited in scope to any particular programming language. The language may be a compiled or interpreted language.

One or more aspects of at least one embodiment may be implemented by representative instructions stored on a non-transitory, machine-readable medium which represents various logic within the processor, which when read by a machine causes the machine to fabricate logic to perform the techniques described herein. Such representations, which may be generally referred to as “IP cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

What is claimed is:

1. An apparatus comprising:
an analog front end circuit to couple to a device;
a transceiver interface circuit to couple to a serial bus controller; and
an adapter circuit coupled between the analog front end circuit and the transceiver interface circuit to convert between a first protocol of the analog front end circuit and a second, different protocol of the transceiver interface circuit.

2. The apparatus of claim 1, wherein the adapter circuit is to convert a disconnect indication for a disconnect from a higher speed of two speeds of data transmittal of the device between the first protocol and the second, different protocol.

3. The apparatus of claim 1, wherein the adapter circuit is to convert a speed selection indication between the first protocol and the second, different protocol to enable a data connection to the device in a higher speed of two non-zero speeds of data transmittal.

4. The apparatus of claim 1, wherein the device comprises a second analog front end circuit coupled to the analog front end circuit, the second analog front end circuit is coupled to a second adapter circuit of the device that is coupled to a second transceiver interface circuit of the device, and the second adapter circuit is to convert between a first protocol of the second analog front end circuit and a second, different protocol of the second transceiver interface circuit.

5. The apparatus of claim 1, wherein the adapter circuit is to convert a power state indication between the first protocol and the second, different protocol.

6. The apparatus of claim 1, wherein the adapter circuit is to convert a suspend indication between the first protocol and the second, different protocol to suspend data transmittal of the device.

7. The apparatus of claim 1, wherein the adapter circuit is to convert a port reset indication between the first protocol of the analog front end circuit and the second, different protocol of the transceiver interface circuit.

8. The apparatus of claim 1, wherein the first protocol is an embedded Universal Serial Bus (eUSB) specification and the second, different protocol is a USB Transceiver Macrocell Interface (UTMI) specification.

9. A method comprising:
providing an analog front end circuit to couple to a device;
providing a transceiver interface circuit to couple to a serial bus controller;
converting between a first protocol of the analog front end circuit and a second, different protocol of the transceiver interface circuit with an adapter circuit coupled between the analog front end circuit and the transceiver interface circuit; and
sending data between the analog front end circuit and the serial bus controller.

10. The method of claim 9, wherein the converting comprises converting a disconnect indication for a disconnect from a higher speed of two speeds of data transmittal of the device between the first protocol and the second, different protocol.

11. The method of claim 9, wherein the converting comprises converting a speed selection indication between the first protocol and the second, different protocol to enable a data connection to the device in a higher speed of two non-zero speeds of data transmittal.

12. The method of claim 9, wherein the device comprises a second analog front end circuit coupled to the analog front end circuit, and the second analog front end circuit is coupled to a second adapter circuit of the device that is coupled to a second transceiver interface circuit of the device, and further comprising converting between a first protocol of the second analog front end circuit and a second, different protocol of the second transceiver interface circuit with the second adapter circuit.

13. The method of claim 9, wherein the converting comprises converting a power state indication between the first protocol and the second, different protocol.

14. The method of claim 9, wherein the converting comprises converting a suspend indication between the first protocol and the second, different protocol to suspend data transmittal of the device.

15. The method of claim 9, wherein the converting comprises converting a port reset indication between the first protocol of the analog front end circuit and the second, different protocol of the transceiver interface circuit.

16. The method of claim 9, wherein the first protocol is an embedded Universal Serial Bus (eUSB) specification and the second, different protocol is a USB Transceiver Macrocell Interface (UTMI) specification.

17. An apparatus comprising:
a physical layer comprising an analog front end circuit to couple to a device;
a transceiver interface circuit to couple to a serial bus controller; and
an adapter circuit coupled between the analog front end circuit and the transceiver interface circuit to convert between a first protocol of the analog front end circuit and a second, different protocol of the transceiver interface circuit.

18. The apparatus of claim 17, wherein the adapter circuit is to convert a disconnect indication for a disconnect from a higher speed of two speeds of data transmittal of the device between the first protocol and the second, different protocol.

19. The apparatus of claim 17, wherein the adapter circuit is to convert a speed selection indication between the first protocol and the second, different protocol to enable a data connection to the device in a higher speed of two non-zero speeds of data transmittal.

20. The apparatus of claim 17, wherein the device comprises a second analog front end circuit coupled to the analog front end circuit, the second analog front end circuit is coupled to a second adapter circuit of the device that is coupled to a second transceiver interface circuit of the device, and the second adapter circuit is to convert between a first protocol of the second analog front end circuit and a second, different protocol of the second transceiver interface circuit.

21. The apparatus of claim 17, wherein the adapter circuit is to convert a power state indication between the first protocol and the second, different protocol.

22. The apparatus of claim 17, further comprising a repeater coupled between the analog front end circuit and the device.

23. The apparatus of claim 17, wherein the adapter circuit is to convert a port reset indication between the first protocol of the analog front end circuit and the second, different protocol of the transceiver interface circuit.

24. The apparatus of claim 17, wherein the first protocol is an embedded Universal Serial Bus (eUSB) specification and the second, different protocol is a USB Transceiver Macrocell Interface (UTMI) specification.
